(19) United States
(12) Patent Application Publication
(10) Pub. No.: US 2008/0268112 A1
(43) Pub. Date: Oct. 30, 2008

(54) Ground Meat and Meat Analog Compositions Having Improved Nutritional Properties

(75) Inventors: Terry Rolan, St. Louis, MO (US); Izumi Mueller, Glen Carbon, IL (US); Thomas J. Mertle, Valley Park, MO (US); Kristen J. Swenson, West Fork, AR (US); Colleen Conley, St. Charles, MO (US); Mac W. Orcutt, St. Louis, MO (US); Lamont E. Mease, Omaha, NE (US)

Correspondence Address: Solae, LLC, 4300 Duncan Avenue, Legal Department E4, St. Louis, MO, 63110, US

(73) Assignee: SOLAE, LLC, St. Louis, MO (US)

(21) Appl. No.: 11/963,375

(22) Filed: Dec. 21, 2007

Related U.S. Application Data
(60) Provisional application No. 60/882,662, filed on Dec. 29, 2006.

(51) Int. Cl. A23L 1/317; A23D 7/005; A23L 1/275

(52) U.S. Cl. 426/250; 426/646; 426/613; 426/601; 426/540

(57) ABSTRACT

The invention provides ground meat and meat analog compositions having reduced fat and cholesterol. The ground meat compositions comprise a structured plant protein product and optionally meat.

### CROSS REFERENCE TO RELATED APPLICATIONS

This application claims priority from U.S. Provisional Application Serial No. 60/882,662, filed on Dec. 28, 2006, which is hereby incorporated by reference in its entirety.

### FIELD OF THE INVENTION

The present invention provides ground meat compositions and meat analog compositions having improved nutritional properties. In particular, the ground meat compositions and meat analog compositions comprise a structured protein product and may optionally include meat.

### BACKGROUND OF THE INVENTION

Given the link between red meat and heart disease and colon cancer, the consumption of red meat has declined over the past thirty years. Despite this decline, however, beef remains the second highest source of protein in the US diet (chicken being the top source). In 2005, Americans on average consumed about 67 pounds of beef per person, with males in general consuming the most ground beef and male teenagers consuming about 95 pounds of beef per person (Davis and Lin 2005). Given the affinity that Americans (and increasingly, others around the world) have for beef patties, there is a need for healthy, reduced-fat beef patty products having the sensory properties (e.g., appearance, flavor, and texture) characteristic of all beef patties.

There have been many attempts to make a healthier beef patty, ranging from all vegetable protein patties to mixtures of beef and vegetable and/or dairy proteins. Many of these, however, lack the proper moisture, flavor, and texture to be accepted by most consumers. What is needed, therefore, is a healthy beef patty with lower levels of cholesterol and fat that not only has the taste and texture of an all beef patty, but also looks like an all beef patty. That is, the healthier beef patty should have a reddish color in the raw state and a brownish color in the cooked state, in addition to great flavor and texture characteristics.

### SUMMARY OF THE INVENTION

One aspect of the invention encompasses a ground meat composition. The ground meat composition comprises structured protein product, the product having protein fibers that are substantially aligned; meat; and an optional color composition having coloring agents selected from the group consisting of a thermally unstable pigment, a thermally stable pigment, and a reducing sugar.

Another aspect of the invention encompasses a meat analog composition. The meat analog composition comprises a structured plant protein product, the product having protein fibers that are substantially aligned, and an optional coloring composition having coloring agents as described above.

Another aspect of the invention provides a process for coloring a ground meat composition or meat analog composition. The process comprises contacting a mixture comprising structured protein product that optionally may include meat, with a coloring composition comprising beet, annatto, carmel coloring, dextrose, and an amino acid source.

A further aspect of the invention encompasses food products comprising ground meat compositions.

Other aspects and features of the invention are described in more detail below.

### REFERENCE TO COLOR FIGURES

The application contains at least one photograph executed in color. Copies of this patent application publication with color photographs will be provided by the Office upon request and payment of the necessary fee.

### FIGURE LEGENDS

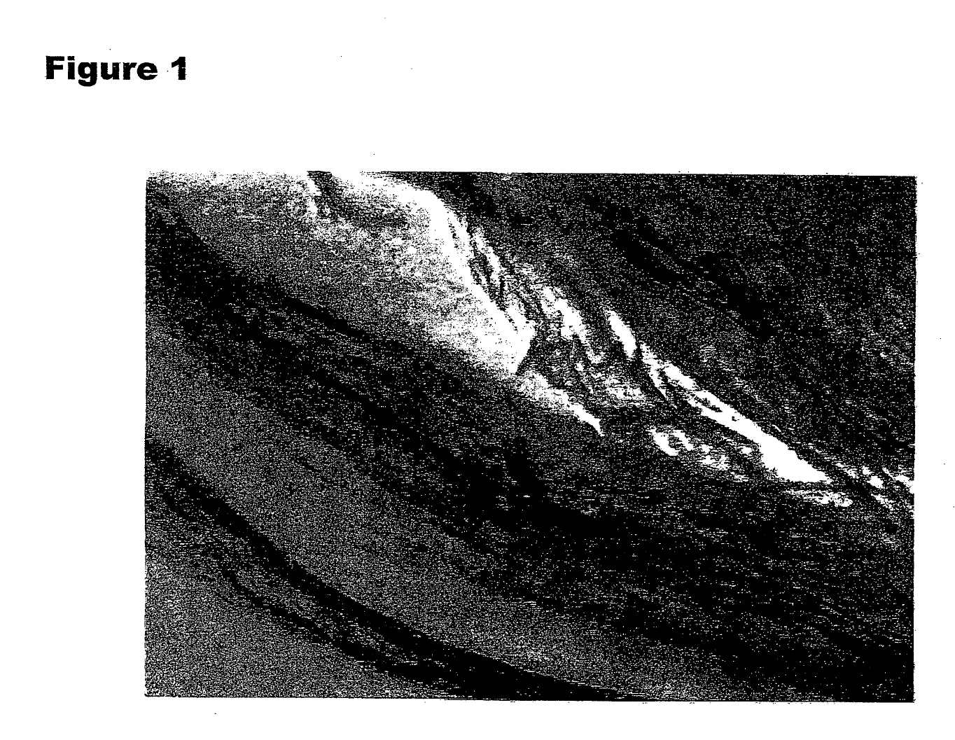

FIG. 1 depicts a photographic image of a micrograph showing a structured plant protein product of the invention having protein fibers that are substantially aligned.

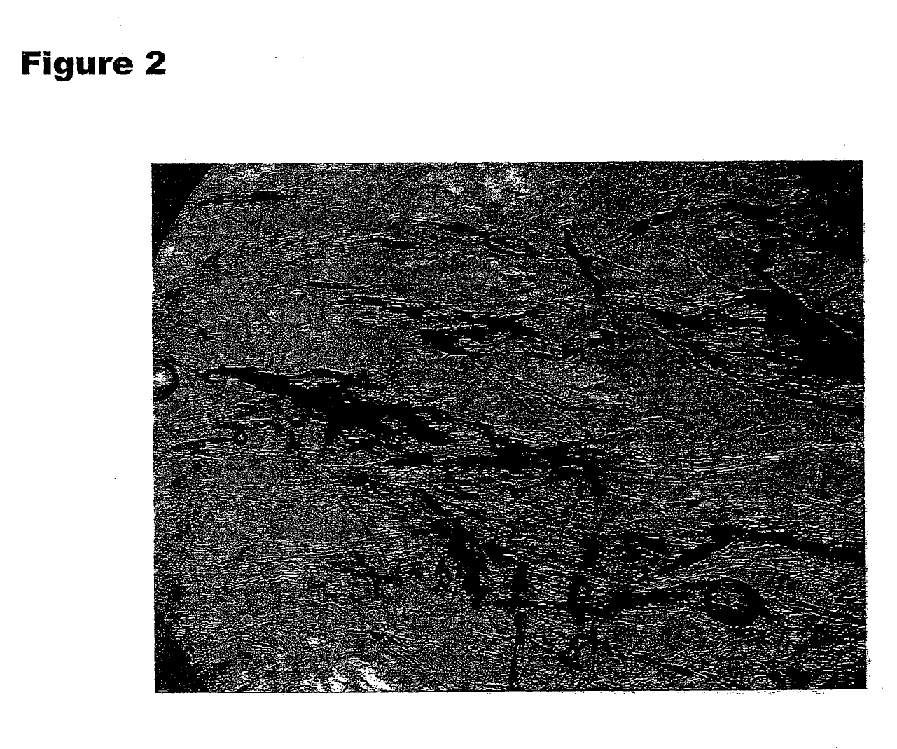

FIG. 2 depicts a photographic image of a micrograph showing a plant protein product not produced by the process of the present invention The protein fibers comprising the plant protein product, as described herein, are crosshatched.

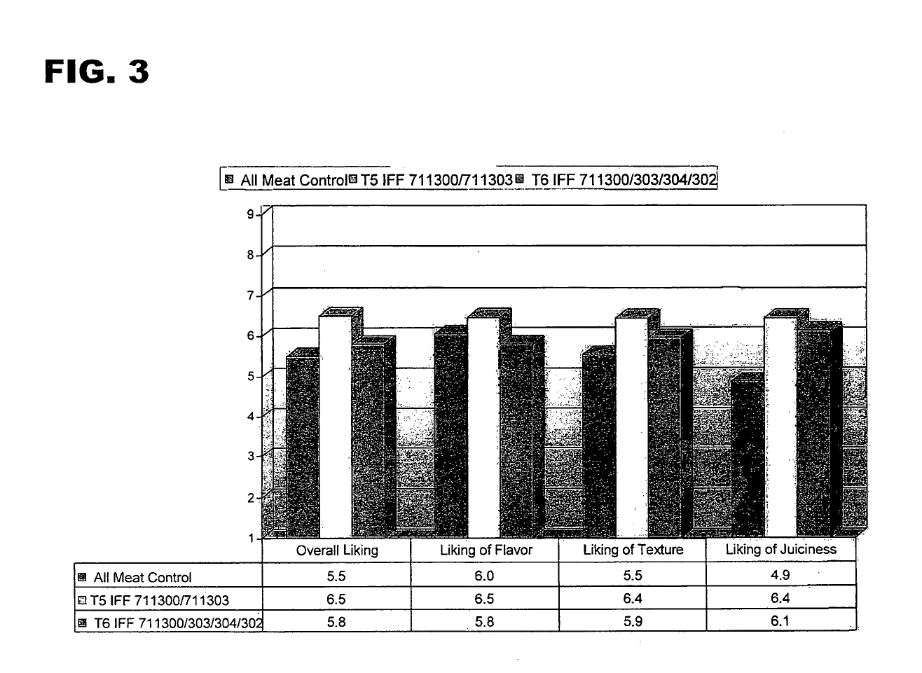

FIG. 3 is a bar graph and table presenting the mean overall liking scores for two different beef/structured vegetable protein patty formulations (T5 and T6) and all beef control patties. The patties were precooked, frozen, and then warmed prior to analysis.

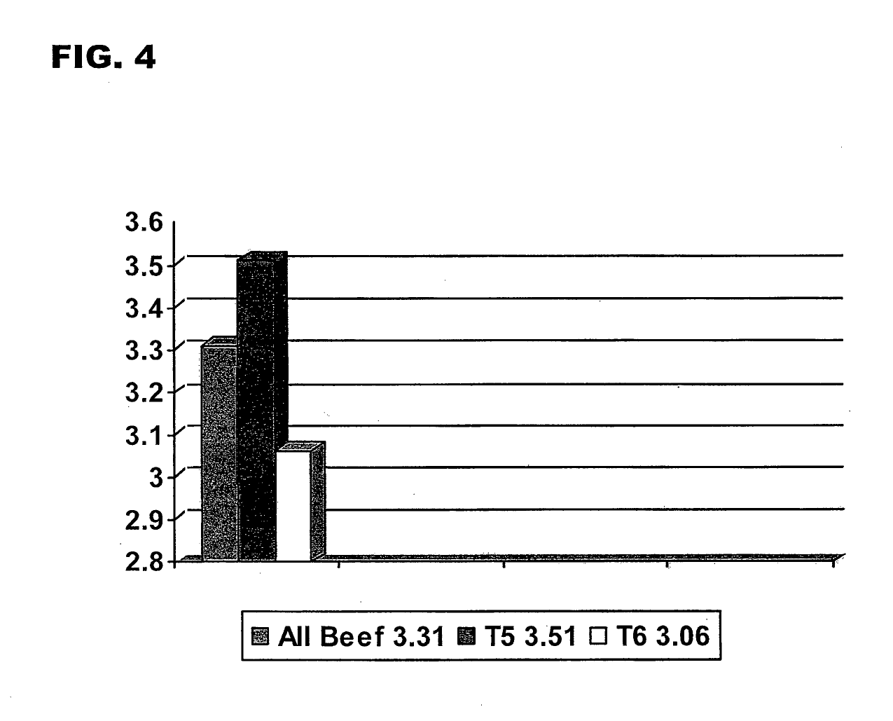

FIG. 4 is a bar graph depicting the mean “similarity to beef” scores for two different beef/structured vegetable protein patty formulations (T5 and T6) and all beef control patties.

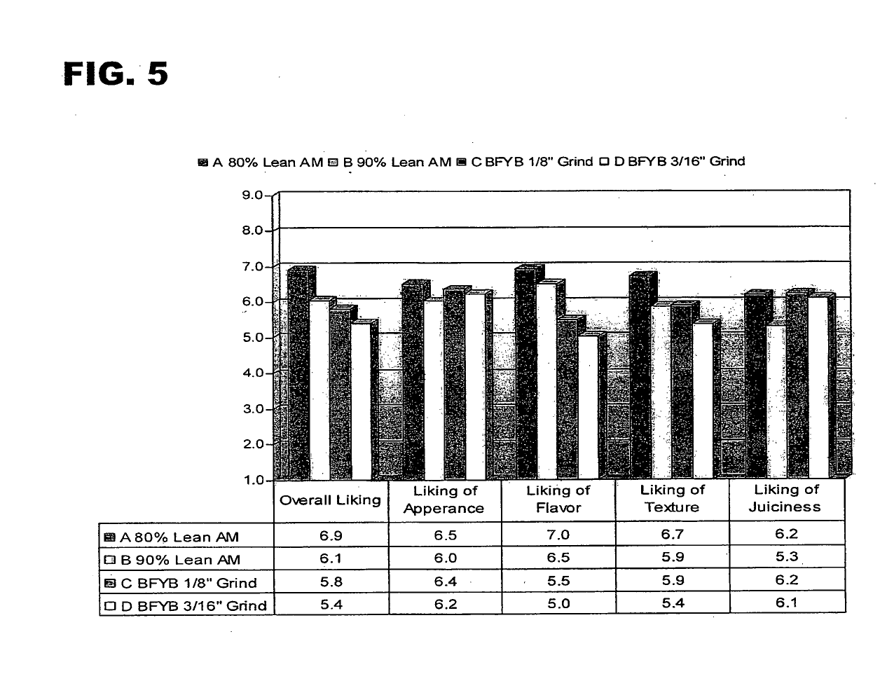

FIG. 5 is a bar graph and table presenting the mean overall liking scores for 80% lean beef, 90% lean beef, beef/SVP ⅛″ grind, and beef/SVP 3/16″ grind patties. The patties were frozen in the raw state and then cooked prior to analysis.

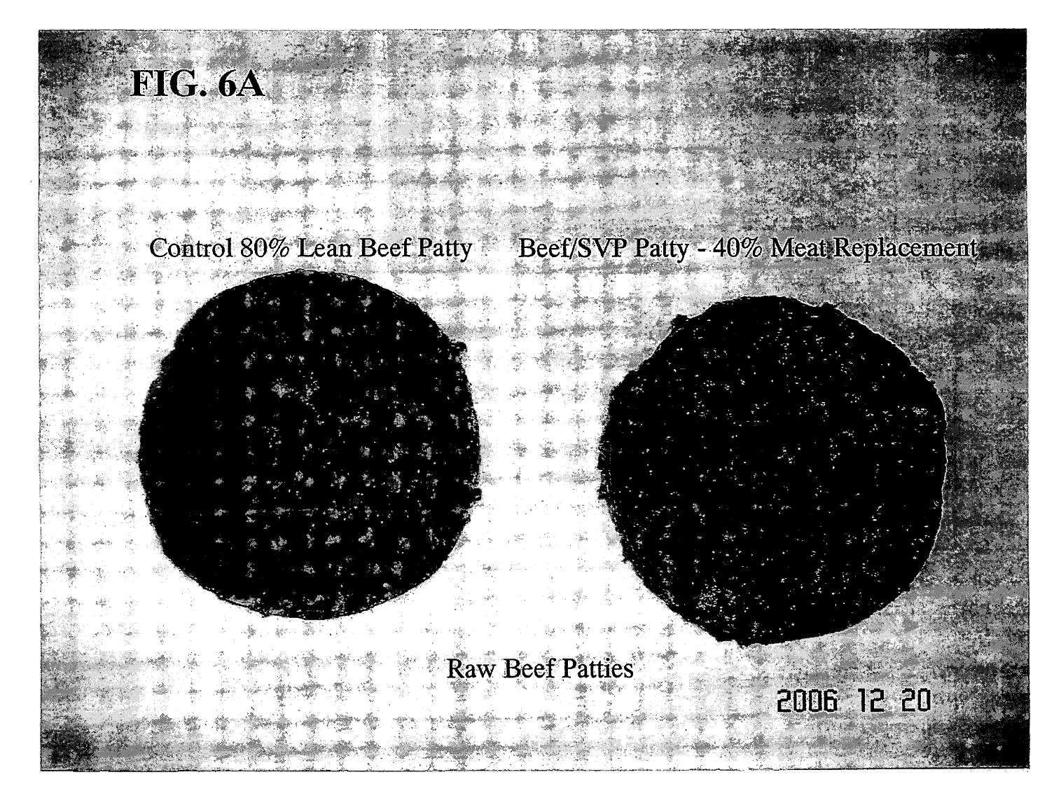

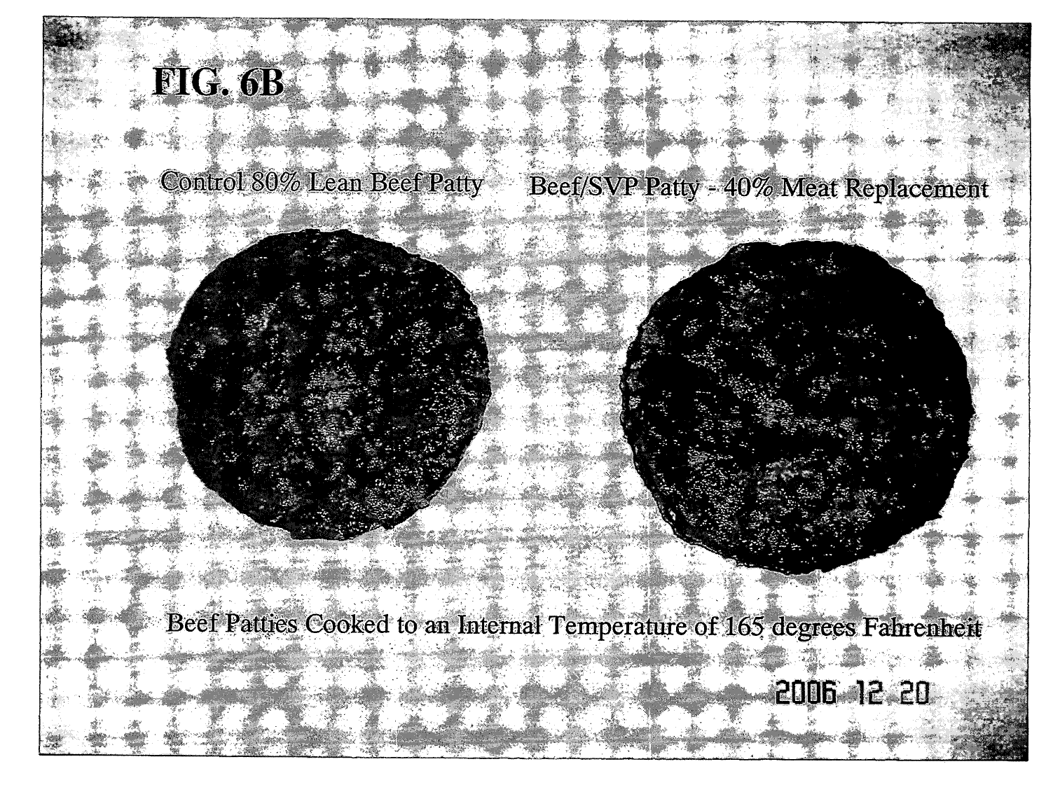

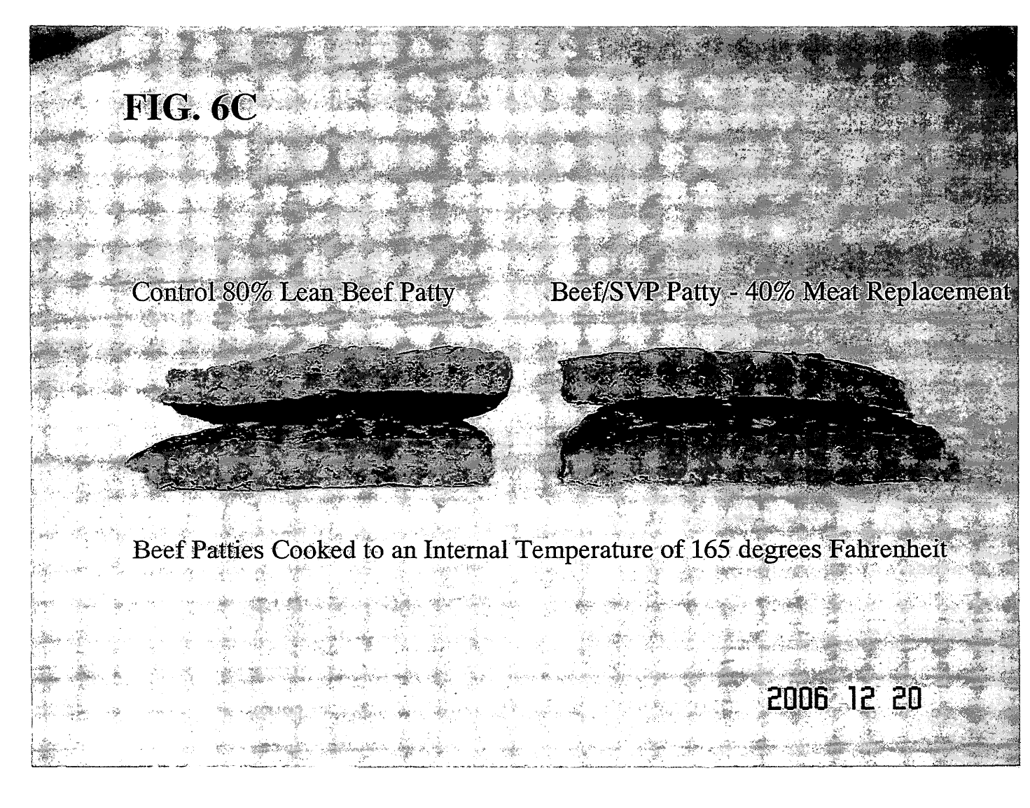

FIG. 6 depicts photographic images of 80% lean all beef patties (left) and beef/SVP patties comprising 40% meat replacement (right). Panel A presents a surface view of raw patties. Panel B presents a surface view and Panel C present a cross-sectional view of patties cooked to an internal temperature of 165° F.

### DETAILED DESCRIPTION OF THE INVENTION

The present invention provides ground meat compositions or simulated ground meat compositions (meat analog compositions) and processes for producing each of the ground meat compositions. Typically, the ground meat composition will comprise animal meat and structured plant protein products having protein fibers that are substantially aligned. Alternatively, the simulated ground meat composition will comprise structured plant protein products having protein fibers that are substantially aligned. Advantageously, as illustrated in the examples, the ground meat compositions of the invention have improved nutritional properties, such as reduced fat and cholesterol, without sacrificing the flavor, texture, mouth feel, and aroma of ground animal meat.

### (I) Structured Protein Products

The ground meat compositions and simulated ground meat compositions of the invention each comprise structured protein products comprising protein fibers that are substantially aligned, as described in more detail in I (f) below. In an exemplary embodiment, the structured protein products are extrudates of protein material that have been subjected to the extrusion process detailed in I(e) below. Because the structured protein products have protein fibers that are substantially aligned in a manner similar to animal meat, the ground meat compositions of the invention generally have the texture, mouthfeel, and eating quality characteristics of compositions comprised of one hundred percent ground animal meat. The resulting products have the meat-like texture consumers desire in a meat or meat substitute product.

(a) Protein-Containing Starting Materials

A variety of ingredients that contain protein may be utilized in a thermal plastic extrusion process to produce structured protein products suitable for use in the ground meat simulated meat compositions. While ingredients comprising proteins derived from plants are typically used, it is also envisioned that proteins derived from other sources, such as animal sources, may be utilized without departing from the scope of the invention. For example, a dairy protein selected from the group consisting of casein, caseinates, whey protein, and mixtures thereof may be utilized. In an exemplary embodiment, the dairy protein is whey protein. By way of further example, an egg protein selected from the group consisting of ovalbumin, ovoglobulin, ovomucin, ovomucoid, ovotransferrin, ovovitella, ovovitellin, albumin globulin, and vitellin may be utilized. Further, meat proteins or protein ingredients consisting of collagen, blood, organ meat, mechanically separated meat, partially defatted tissue and blood serum proteins may be included as one or more of the ingredients of the structured protein products.

It is envisioned that other ingredient types in addition to proteins may be utilized. Non-limiting examples of such ingredients include sugars, starches, oligosaccharides, soy fiber, and other dietary fibers.

While in some embodiments gluten may be used as a protein, it is also envisioned that the protein-containing starting materials may be gluten-free. Because gluten is typically used in filament formation during the extrusion process, if a gluten-free starting material is used, an edible cross-linking agent may be utilized to facilitate filament formation. Non-limiting examples of suitable cross-linking agents include Konjac glucomannan (KGM) flour, BetaGlucan manufactured by Takeda (USA), transglutaminase, calcium salts, and magnesium salts. One skilled in the art can readily determine the amount of cross-linking material needed, if any, in gluten-free embodiments.

Irrespective of its source or ingredient classification, the ingredients utilized in the extrusion process are typically capable of forming extrudates having protein fibers that are substantially aligned. Suitable examples of such ingredients are detailed more fully below.

(i) Plant Protein Materials

In an exemplary embodiment, at least one ingredient derived from a plant will be utilized to form the protein-containing materials. Generally speaking, the ingredient will comprise a protein. The amount of protein present in the ingredient(s) utilized can and will vary depending upon the application. For example, the amount of protein present in the ingredient(s) utilized may range from about 40% to about 100% by weight. In another embodiment, the amount of protein present in the ingredient(s) utilized may range from about 50% to about 100% by weight. In an additional embodiment, the amount of protein present in the ingredient(s) utilized may range from about 60% to about 100% by weight. In a further embodiment, the amount of protein present in the ingredient(s) utilized may range from about 70% to about 100% by weight. In still another embodiment, the amount of protein present in the ingredient(s) utilized may range from about 80% to about 100% by weight. In a further embodiment, the amount of protein present in the ingredient(s) utilized may range from about 90% to about 100% by weight.

The ingredient(s) utilized in extrusion may be derived from a variety of suitable plants. By way of non-limiting example, suitable plants include legumes, corn, peas, canola, sunflowers, sorghum, rice, amaranth, potato, tapioca, arrowroot, canna, lupin, rape, wheat, oats, rye, barley, and mixtures thereof.

In one embodiment, the ingredients are isolated from wheat and soybeans. In another exemplary embodiment, the ingredients are isolated from soybeans. Suitable wheat derived protein-containing ingredients include wheat gluten, wheat flour, and mixtures thereof. Examples of commercially available wheat gluten that may be utilized in the invention include Manildra Gem of the West Gluten, Vital Wheat Gluten (organic) each of which is available from Manildra Milling. Suitable soybean derived protein-containing ingredients (“soy protein material”) include soybean protein isolate, soy protein concentrate, soy flour, and mixtures thereof, each of which are detailed below. In each of the foregoing embodiments, the soybean material may be combined with one or more ingredients selected from the group consisting of a starch, flour, gluten, a dietary fiber, and mixtures thereof.

Suitable examples of protein-containing material isolated from a variety of sources are detailed in Table A, which shows various combinations.

TABLE A
Protein Combinations

| First protein source | second ingredient |
|---|---|
| soybean | wheat |
| soybean | dairy |
| soybean | egg |
| soybean | corn |
| soybean | rice |
| soybean | barley |
| soybean | sorghum |
| soybean | oat |
| soybean | millet |
| soybean | rye |
| soybean | triticale |
| soybean | buckwheat |
| soybean | pea |
| soybean | peanut |
| soybean | lentil |
| soybean | lupin |
| soybean | channa (garbonzo) |
| soybean | rapeseed (canola) |
| soybean | cassava |
| soybean | sunflower |
| soybean | whey |
| soybean | tapioca |
| soybean | arrowroot |
| soybean | amaranth |
| soybean | wheat and dairy |
| soybean | wheat and egg |
| soybean | wheat and corn |
| soybean | wheat and rice |
| soybean | wheat and barley |
| soybean | wheat and sorghum |
| soybean | wheat and oat |
| soybean | wheat and millet |
| soybean | wheat and rye |
| soybean | wheat and triticale |
| soybean | wheat and buckwheat |
| soybean | wheat and pea |
| soybean | wheat and peanut |
| soybean | wheat and lentil |
| soybean | wheat and lupin |
| soybean | wheat and channa (garbonzo) |
| soybean | wheat and rapeseed (canola) |
| soybean | wheat and cassava |
| soybean | wheat and sunflower |
| soybean | wheat and potato |
| soybean | wheat and tapioca |
| soybean | wheat and arrowroot |
| soybean | wheat and amaranth |
| soybean | corn and wheat |
| soybean | corn and dairy |
| soybean | corn and egg |
| soybean | corn and rice |
| soybean | corn and barley |
| soybean | corn and sorghum |
| soybean | corn and oat |
| soybean | corn and millet |
| soybean | corn and rye |
| soybean | corn and triticale |
| soybean | corn and buckwheat |
| soybean | corn and pea |
| soybean | corn and peanut |
| soybean | corn and lentil |
| soybean | corn and lupin |
| soybean | corn and channa (garbonzo) |
| soybean | corn and rapeseed (canola) |
| soybean | corn and cassava |
| soybean | corn and sunflower |
| soybean | corn and potato |
| soybean | corn and tapioca |
| soybean | corn and arrowroot |
| soybean | corn and amaranth |

In each of the embodiments delineated in Table A, the combination of protein-containing materials may be combined with one or more ingredients selected from the group consisting of a starch, flour, gluten, a dietary fiber, and mixtures thereof. In one embodiment, the protein-containing material comprises protein, starch, gluten, and fiber. In an exemplary embodiment, the protein-containing material comprises from about 45% to about 65% soy protein on a dry matter basis; from about 20% to about 30% wheat gluten on a dry matter basis; from about 10% to about 15% wheat starch on a dry matter basis; and from about 1% to about 5% starch on a dry matter basis. In each of the foregoing embodiments, the protein-containing material may comprise dicalcium phosphate, L-cysteine or combinations of both dicalcium phosphate and L-cysteine.

(ii) Soy Protein Materials

In an exemplary embodiment, as detailed above, soy protein isolate, soy protein concentrate, soy flour, and mixtures thereof may be utilized in the extrusion process. The soy protein materials may be derived from whole soybeans in accordance with methods generally known in the art. The whole soybean may be standard soybeans (i.e., non genetically modified soybeans), commoditized soybeans, genetically modified soybeans, and combinations thereof.

Generally speaking, when soy isolate is used, an isolate is preferably selected that is not a highly hydrolyzed soy protein isolate. In certain embodiments, highly hydrolyzed soy protein isolates, however, may be used in combination with other soy protein isolates provided that the highly hydrolyzed soy protein isolate content of the combined soy protein isolates is generally less than about 40% of the combined soy protein isolates, by weight. Additionally, the soy protein isolate utilized preferably has an emulsion strength and gel strength sufficient to enable the protein in the isolate to form fibers that are substantially aligned upon extrusion. It is also possible to use membrane filtered soy isolates. Examples of soy protein isolates that are useful in the present invention are commercially available, for example, from Solae, LLC (St. Louis, Mo.), and include SUPRO® 500E, SUPRO® EX 33, SUPRO® 620, SUPRO® 630, SUPRO® EX45, SUPRO® 595, and SUPRO® 545. In an exemplary embodiment, a form of SUPRO® 620 is utilized as detailed in Example 8.

Alternatively, soy protein concentrate may be blended with the soy protein isolate to substitute for a portion of the soy protein isolate as a source of soy protein material. Typically, if a soy protein concentrate is substituted for a portion of the soy protein isolate, the soy protein concentrate is substituted for up to about 55% of the soy protein isolate by weight. The soy protein concentrate can be substituted for up to about 50% of the soy protein isolate by weight. It is also possible in an embodiment to substitute 40% by weight of the soy protein concentrate for the soy protein isolate. In another embodiment, the amount of soy protein concentrate substituted is up to about 30% of the soy protein isolate by weight. Examples of suitable soy protein concentrates useful in the invention include PROCON, ALPHA 12, and ALPHA 5800, which are commercially available from Solae, LLC (St. Louis, Mo.). If soy flour is substituted for a portion of the soy protein isolate, the soy flour is substituted for up to about 35% of the soy protein isolate by weight. The soy flour should be a high protein dispersibility index (PDI) soy flour.

Any fiber known in the art can be used as the fiber source in the application. Soy cotyledon fiber may optionally be utilized as a fiber source. Typically, suitable soy cotyledon fiber will generally effectively bind water when the mixture of soy protein and soy cotyledon fiber is extruded. In this context, “effectively bind water” generally means that the soy cotyledon fiber has a water holding capacity of at least 5.0 to about 8.0 grams of water per gram of soy cotyledon fiber, and preferably the soy cotyledon fiber has a water holding capacity of at least about 6.0 to about 8.0 grams of water per gram of soy cotyledon fiber. When present in the soy protein material, soy cotyledon fiber may generally be present in the soy protein material in an amount ranging from about 1% to about 20%, preferably from about 1.5% to about 20% and most preferably, at from about 2% to about 5% by weight on a moisture free basis. Suitable soy cotyledon fiber is commercially available. For example, FIBRIM® 1260 and FIBRIM® 2000 are soy cotyledon fiber materials that are commercially available from Solae, LLC (St. Louis, Mo.).

### (b) Reducing Sugar

The protein-containing material detailed in l(a) may optionally be combined with at least one reducing sugar and co-extruded. Alternatively, the reducing sugar may be combined with the structured protein product after its extrusion. Generally speaking, when the mixture of protein-containing material and reducing sugar is subjected to an elevated temperature, the mixture undergoes a Maillard reaction, which typically produces a product having a dark color (e.g., brown or tan) and savory flavor. Without being bound by any particular theory, it is believed that the Maillard reaction is typically initiated by a non-enzymatic condensation of the reducing sugar, with a primary amine group that is present within the protein-containing material, to form a Schiff base; which then undergoes an Amadori rearrangement to regenerate carbonyl activity (see, e.g., Smith et al. (1993) Proc. Natl. Acad. Sci. USA 91, 5710-5714).

A variety of reducing sugars are suitable for use in the present invention to the extent the reducing sugar is capable of undergoing a Maillard reaction with protein-containing material when the combination is subjected to elevated temperature. The reducing sugar may be a monosaccharide, a disaccharide or a polysaccharide. Exemplary monosaccharide reducing sugars include pentoses and hexoses. Other suitable reducing sugars include ribose, xylose, arabinose, lactose, glyceraldehyde, fructose, maltose, and dextrose (glucose).

As will be appreciated by the skilled artisan the amount of reducing sugar combined with the protein-containing material can and will vary depending upon the desired color of the resulting product. For example, the amount of reducing sugar may range from about 0.001% to about 15% on a dry matter basis of the protein-containing materials. In another embodiment, the amount of reducing sugar may range from 0.05% to about 10% by weight on a dry matter basis of the protein-containing materials. In yet another embodiment, the amount of reducing sugar may range from about 0.05% to about 2% by weight on a dry matter basis of the protein-containing materials.

### (c) Additional Ingredients

A variety of additional ingredients may be added to any of the combinations of protein-containing materials and reducing sugars detailed above without departing from the scope of the invention. For example, antioxidants, antimicrobial agents, and combinations thereof may be included. Antioxidant additives include BHA, BHT, TBHQ, vitamins A, C and E and derivatives thereof. Additionally, various plant extracts such as those containing carotenoids, tocopherols or flavonoids having antioxidant properties, may be included to increase the shelf-life or nutritionally enhance the ground meat (animal meat) or simulated meat compositions. The antioxidants and the antimicrobial agents may have a combined presence at levels of from about 0.01% to about 10%, preferably, from about 0.05% to about 5%, and more preferably from about 0.1% to about 2%, by weight of the protein-containing materials that will be extruded.

### (d) Moisture Content

As will be appreciated by the skilled artisan, the moisture content of the protein-containing materials and optional additional ingredients can and will vary depending on the thermal process the combination is subjected to e.g. retort cooking, microwave cooking, and extrusion. Generally speaking in extrusion applications, the moisture content may range from about 1% to about 80% by weight. In low moisture extrusion applications, the moisture content of the protein-containing materials may range from about 1% to about 35% by weight. Alternatively, in high moisture extrusion applications, the moisture content of the protein-containing materials may range from about 35% to about 80% by weight. In an exemplary embodiment, the extrusion application utilized to form the extrudates is low moisture. An exemplary example of a low moisture extrusion process to produce extrudates having proteins with fibers that are substantially aligned is detailed in I(e) and Example 8.

### (e) Extrusion of the Protein-Containing Material

A suitable extrusion process for the preparation of structured protein products comprises introducing the protein material which includes plant protein material and optionally other protein material, and other ingredients into a mixing vessel (i.e., an ingredient blender) to combine the ingredients and form a dry blended protein material pre-mix. The dry blended protein material pre-mix may be transferred to a hopper from which the dry blended ingredients are introduced along with moisture into a pre-conditioner to form a conditioned protein material mixture. The conditioned material is then fed to an extruder in which the mixture is heated under mechanical pressure generated by the screws of the extruder to form a molten extrusion mass. Alternatively, the dry blended protein material pre-mix may be directly fed to an extruder in which moisture and heat are introduced to from a molten extrusion mass. The molten extrusion mass exits the extruder through an extrusion die forming an extrudate comprising structured protein products having protein fibers that are substantially aligned.

(i) Extrusion Process Conditions

Among the suitable extrusion apparatuses useful in the practice of the present invention is a double barrel, twin-screw extruder as described, for example, in U.S. Pat. No. 4,600,311 Further examples of suitable commercially available extrusion apparatuses include a CLEXTRAL Model BC-72 extruder manufactured by Clextral, Inc. (Tampa, Fla.); a WENGER Model TX-57 extruder, a WENGER Model TX-168 extruder, and a WENGER Model TX-52 extruder all manufactured by Wenger Manufacturing, Inc. (Sabetha, Kans.). Other conventional extruders suitable for use in this invention are described, for example, in U.S. Pat. Nos. 4,763,569, 4,118,164, and 3,117,006, which are hereby incorporated by reference in their entirety.

A single-screw extruder could also be used in the present invention. Examples of suitable, commercially available single-screw extrusion apparatuses include the WENGER Model X-175, the WENGER Model X-165, and the WENGER Model X-85, all of which are available from Wenger Manufacturing, Inc.

The screws of a twin-screw extruder can rotate within the barrel in the same or opposite directions. Rotation of the screws in the same direction is referred to as single flow whereas rotation of the screws in opposite directions is referred to as double flow or counter rotating. The speed of the screw or screws of the extruder may vary depending on the particular apparatus, however, it is typically from about 250 to about 450 revolutions per minute (rpm). Generally, as the screw speed increases, the density of the extrudate will decrease. The extrusion apparatus contains screws assembled from shafts and worm segments, as well as mixing lobe and ring-type shearlock elements as recommended by the extrusion apparatus manufacturer for extruding plant protein material.

The extrusion apparatus generally comprises a plurality of heating zones through which the protein mixture is conveyed under mechanical pressure prior to exiting the extrusion apparatus through an extrusion die. The temperature in each successive heating zone generally exceeds the temperature of the previous heating zone by between about 10° C. and about 70° C. In one embodiment, the conditioned pre-mix is transferred through four heating zones within the extrusion apparatus, with the protein mixture heated to a temperature of from about 100° C. to about 150° C. such that the molten extrusion mass enters the extrusion die at a temperature of from about 100° C. to about 150° C. One skilled in the art could adjust the temperature either heating or cooling to achieve the desired properties. Typically, temperature changes are due to work input and can happen suddenly.

The pressure within the extruder barrel is typically between about 50 psig to about 500 psig preferably between about 75 psig to about 200 psig. Generally, the pressure within the last two heating zones is from about 100 psig to about 3000 psig preferably between about 150 psig to about 500 psig. The barrel pressure is dependent on numerous factors including, for example, the extruder screw speed, feed rate of the mixture to the barrel, feed rate of water to the barrel, and the viscosity of the molten mass within the barrel.

Water is injected into the extruder barrel to hydrate the plant protein material mixture and promote texturization of the proteins. As an aid in forming the molten extrusion mass, the water may act as a plasticizing agent. Water may be introduced to the extruder barrel via one or more injection jets in communication with a heating zone. Typically, the mixture in the barrel contains from about 15% to about 35% by weight water. The rate of introduction of water to any of the heating zones is generally controlled to promote production of an extrudate having desired characteristics. It has been observed that as the rate of introduction of water to the barrel decreases, the density of the extrudate decreases. Typically, less than about 1 kg of water per kg of protein is introduced to the barrel. Preferably, from about 0.1 kg to about 1 kg of water per kg of protein are introduced to the barrel.

(ii) Optional Preconditioning

In a pre-conditioner, the protein-containing material, reducing sugar and other ingredients (protein-containing mixture) are preheated, contacted with moisture, and held under controlled temperature and pressure conditions to allow the moisture to penetrate and soften the individual particles. The preconditioning step increases the bulk density of the particulate fibrous material mixture and improves its flow characteristics. The preconditioner contains one or more paddles to promote uniform mixing of the protein and transfer of the protein mixture through the preconditioner. The configuration and rotational speed of the paddles vary widely, depending on the capacity of the preconditioner, the extruder throughput and/or the desired residence time of the mixture in the preconditioner or extruder barrel. Generally, the speed of the paddles is from about 100 to about 1300 revolutions per minute (rpm). Agitation must be high enough t to obtain even hydration and good mixing.

Typically, the protein-containing mixture is pre-conditioned prior to introduction into the extrusion apparatus by contacting the pre-mix with moisture (i.e., steam and/or water). Preferably the protein-containing mixture is heated to a temperature of from about 25° C. to about 80° C., more preferably from about 30° C. to about 40° C. in the preconditioner using appropriate water temperature.

Typically, the protein-containing pre-mix is conditioned for a period of about 30 to about 60 seconds, depending on the speed and the size of the preconditioner. The pre-mix is contacted with steam and/or water and heated in the preconditioner at generally constant steam flow to achieve the desired temperatures. The water and/or steam conditions (i.e., hydrates) the pre-mix, increases its density, and facilitates the flowability of the dried mix without interference prior to introduction to the extruder barrel where the proteins are texturized. If low moisture pre-mix is desired, the conditioned pre-mix may contain from about 1% to about 35% (by weight) water. If high moisture pre-mix is desired, the conditioned pre-mix may contain from about 35% to about 80% (by weight) water.

The conditioned pre-mix typically has a bulk density of from about 0.25 g/cm³ to about 0.6 g/cm³. Generally, as the bulk density of the pre-conditioned protein mixture increases within this range, the protein mixture is easier to process. This is presently believed to be due to such mixtures occupying all or a majority of the space between the screws of the extruder, thereby facilitating conveying the extrusion mass through the barrel.

(iii) Extrusion Process

The dry pre-mix or the conditioned pre-mix is then fed into an extruder to heat, shear, and ultimately plasticize the mixture. The extruder may be selected from any commercially available extruder and may be a single screw extruder or preferably a twin-screw extruder that mechanically shears the mixture with the screw elements.

Whatever extruder is used, it should be run in excess of about 50% motor load. The rate at which the pre-mix is generally introduced to the extrusion apparatus will vary depending upon the particular apparatus. Typically, the conditioned pre-mix is introduced to the extrusion apparatus at a rate of between about 16 kilograms per minute to about 60 kilograms per minute. In another embodiment, the conditioned pre-mix is introduced to the extrusion apparatus at a rate between 20 kilograms per minute to about 40 kilograms per minute. The conditioned pre-mix is introduced to the extrusion apparatus at a rate of between about 26 kilograms per minute to about 32 kilograms per minute. Generally, it has been observed that the density of the extrudate decreases as the feed rate of pre-mix to the extruder increases.

The pre-mix is subjected to shear and pressure by the extruder to plasticize the mixture. The screw elements of the extruder shear the mixture as well as create pressure in the extruder by forcing the mixture forwards though the extruder and through the die. The screw motor speed determines the amount of shear and pressure applied to the mixture by the screw(s). Preferably, the screw motor speed is set to a speed of from about 200 rpm to about 500 rpm, and more preferably from about 300 rpm to about 450 rpm, which moves the mixture through the extruder at a rate of at least about 20 kilograms per hour, and more preferably at least about 40 kilograms per hour. Preferably, the extruder generates an extruder barrel exit pressure of from about 50 to about 3000 psig, and more preferably an extruder barrel exit pressure of from about 600 to about 1000 psig is generated.

The extruder controls the temperature of the mixture as it passes through the extruder denaturing the protein in the mixture. The extruder includes a means for heating the mixture to temperatures of from about 100° C. to about 180° C. Preferably the means for heating the mixture in the extruder comprises extruder barrel jackets into which heating or cooling media such as steam or water may be introduced to control the temperature of the mixture passing through the extruder. The extruder may also include steam injection ports for directly injecting steam into the mixture within the extruder. The extruder preferably includes multiple heating zones that can be controlled to independent temperatures, where the temperatures of the heating zones are preferably set to increase the temperature of the mixture as it proceeds through the extruder. For example, the extruder may be set in a four temperature zone arrangement, where the first zone (adjacent the extruder inlet port) is set to a temperature of from about 80° C. to about 100° C., the second zone is set to a temperature of from about 100° C. to 135° C., the third zone is set to a temperature of from 135° C. to about 150° C., and the fourth zone (adjacent the extruder exit port) is set to a temperature of from 150° C. to 180° C. The extruder may be set in other temperature zone arrangements, as desired. For example, the extruder may be set in a five temperature zone arrangement, where the first zone is set to a temperature of about 25° C., the second zone is set to a temperature of about 50° C., the third zone is set to a temperature of about 95° C., the fourth zone is set to a temperature of about 130° C., and the fifth zone is set to a temperature of about 150° C.

The mixture forms a melted plasticized mass in the extruder. A die assembly is attached to the extruder in an arrangement that permits the plasticized mixture to flow from the extruder exit port into the die assembly, wherein the die assembly consists of a die and a back plate. The back plate is attached to the inner face of the die for the purpose of directing the flow of material entering the die towards the die aperture(s). Additionally, the die assembly produces substantial alignment of the protein fibers within the plasticized mixture as it flows through the die assembly. The back plate in combination with the die creates a central chamber that receives the melted plasticized mass from the extruder through a central opening. From at least one central chamber, the melted plasticized mass is directed by flow directors into at least one elongated tapered channel. Each elongated tapered channel leads directly to an individual die aperture. The extrudate exits the die through at least one aperture in the periphery or side of the die assembly at which point the protein fibers contained within are substantially aligned. It is also contemplated that the extrudate may exit the die assembly through at least one aperture in the die face, which may be a die plate affixed to the die.

The width and height dimensions of the die aperture(s) are selected and set prior to extrusion of the mixture to provide the fibrous material extrudate with the desired dimensions. The width of the die aperture(s) may be set so that the extrudate resembles from a cubic chunk of meat to a steak filet, where widening the width of the die aperture(s) decreases the cubic chunk-like nature of the extrudate and increases the filet-like nature of the extrudate. Preferably the width of the die aperture(s) is/are set to a width of from about 5 millimeters to about 40 millimeters.

The height dimension of the die aperture(s) may be set to provide the desired thickness of the extrudate. The height of the aperture(s) may be set to provide a very thin extrudate or a thick extrudate. Preferably, the height of the die aperture(s) may be set to from about 1 millimeter to about 30 millimeters, and more preferably from about 8 millimeters to about 16 millimeters.

It is also contemplated that the die aperture(s) may be round. The diameter of the die aperture(s) may be set to provide the desired thickness of the extrudate. The diameter of the aperture(s) may be set to provide a very thin extrudate or a thick extrudate. Preferably, the diameter of the die aperture(s) may be set to from about 1 millimeter to about 30 millimeters, and more preferably from about 8 millimeters to about 16 millimeters.

The extrudate can be cut after exiting the die assembly. Suitable apparatuses for cutting the extrudate include flexible knives manufactured by Wenger Manufacturing, Inc. (Sabetha, Kans.) and Clextral, Inc. (Tampa, Fla.). A delayed cut can also be done to the extrudate. One such example of a delayed cut device is a guillotine device.

The dryer, if one is used, generally comprises a plurality of drying zones in which the air temperature may vary. Examples known in the art include convection dryers. The extrudate will be present in the dryer for a time sufficient to produce an extrudate having the desired moisture content. Thus, the temperature of the air is not important; if a lower temperature is used (such as 50° C.) longer drying times will be required than if a higher temperature is used. Generally, the temperature of the air within one or more of the zones will be from about 100° C. to about 185° C. At such temperatures the extrudate is generally dried for at least about 45 minutes and more generally, for at least about 65 minutes. Suitable dryers include those manufactured by Wolverine Proctor & Schwartz (Merrimac, Mass.), National Drying Machinery Co. (Philadelphia, Pa.), Wenger (Sabetha, Kans,), Clextral (Tampa, Fla.), and Buehler (Lake Bluff, Ill.).

Another option is to use microwave assisted drying. In this embodiment, a combination of convective and microwave heating is used to dry the product to the desired moisture. Microwave assisted drying is accomplished by simultaneously using forced-air convective heating and drying to the surface of the product while at the same time exposing the product to microwave heating that forces the moisture that remains in the product to the surface whereby the convective heating and drying continues to dry the product. The convective dryer parameters are the same as discussed previously. The addition is the microwave-heating element, with the power of the microwave being adjusted dependent on the product to be dried as well as the desired final product moisture. As an example the product can be conveyed through an oven that contains a tunnel that is equipped with wave-guides to feed the microwave energy to the product and chokes designed to prevent the microwaves from leaving the oven. As the product is conveyed through the tunnel the convective and microwave heating simultaneously work to lower the moisture content of the product whereby drying. Typically, the air temperature is 50° C. to about 80° C., and the microwave power is varied dependent on the product, the time the oven is in the oven, and the final moisture content desired.

The desired moisture content may vary widely depending on the intended application of the extrudate. Generally speaking, the extruded material has a moisture content of less than 10% moisture and typically from about 5% to about 11% by weight, if dried. Although not required in order to separate the fibers, hydrating in water until the water is absorbed is one way to separate the fibers. If the protein material is not dried or not fully dried and is to be used immediately, its moisture content can be higher, generally from about 16% to about 30% by weight. If a protein material with high moisture content is produced, the protein material may require immediate use or refrigeration to ensure product freshness, and minimize spoilage.

The dried extrudate may further be comminuted to reduce the average particle size of the extrudate. Suitable grinding apparatus include hammer mills such as Mikro Hammer Mills manufactured by Hosokawa Micron Ltd. (England), Fitzmill® manufactured by the Fitzpatrick Company (Elmhurst, Ill.), Comitrol® processors made by Urschel Laboratories, Inc. (Valparaiso, Ind.), and roller mills such as RossKamp Roller Mills manufactured by RossKamp Champion (Waterloo, Ill.).

### (f) Characterization of the Structured Protein Products

The extrudates produced in I(e) typically comprise the structured protein products having protein fibers that are substantially aligned. In the context of this invention “substantially aligned” generally refers to the arrangement of protein fibers such that a significantly high percentage of the protein fibers forming the structured protein product are contiguous to each other at less than approximately a 45° angle when viewed in a horizontal plane. Typically, an average of at least 55% of the protein fibers comprising the structured protein product are substantially aligned. In another embodiment, an average of at least 60% of the protein fibers comprising the structured protein product are substantially aligned. In a further embodiment, an average of at least 70% of the protein fibers comprising the structured protein product are substantially aligned. In an additional embodiment, an average of at least 80% of the protein fibers comprising the structured protein product are substantially aligned. In yet another embodiment, an average of at least 90% of the protein fibers comprising the structured protein product are substantially aligned. Methods for determining the degree of protein fiber alignment are known in the art and include visual determinations based upon micrographic images. By way of example, FIGS. 1 and 2 depict micrographic images that illustrate the difference between a structured protein product having substantially aligned protein fibers compared to a protein product having protein fibers that are significantly crosshatched. FIG. 1 depicts a structured protein product prepared according to I(a)-I(e) having protein fibers that are substantially aligned. Contrastingly, FIG. 2 depicts a protein product containing protein fibers that are significantly crosshatched and not substantially aligned. Because the protein fibers are substantially aligned, as shown in FIG. 1, the structured protein products utilized in the invention generally have the texture and consistency of cooked muscle meat. In contrast, extrudates having protein fibers that are randomly oriented or crosshatched generally have a texture that is soft or spongy.

In certain embodiments where the protein material is co-extruded with a reducing sugar, a Maillard reaction may occur, and the resulting structured protein products generally have a dark color. Depending upon the reaction conditions, the color can be optimized to match the color of a desired ground animal meat product. In some embodiments, the color may be a shade of brown, e.g., light brown, medium brown, and dark brown. In other embodiments, the color may be a shade of tan, e.g., light tan, medium tan, and dark tan.

In addition to having protein fibers that are substantially aligned, the structured protein products also typically have shear strength substantially similar to whole meat muscle. In this context of the invention, the term “shear strength” provides one means to quantify the formation of a sufficient fibrous network to impart whole-muscle like texture and appearance to the structured protein product. Shear strength is the maximum force in grams needed to shear through a given sample. A method for measuring shear strength is described in Example 6. Generally speaking, the structured protein products of the invention will have average shear strength of at least 1400 grams. In an additional embodiment, the structured protein products will have average shear strength of from about 1500 to about 1800 grams. In yet another embodiment, the structured protein products will have average shear strength of from about 1800 to about 2000 grams. In a further embodiment, the structured protein products will have average shear strength of from about 2000 to about 2600 grams. In an additional embodiment, the structured protein products will have average shear strength of at least 2200 grams. In a further embodiment, the structured protein products will have average shear strength of at least 2300 grams. In yet another embodiment, the structured protein products will have average shear strength of at least 2400 grams. In still another embodiment, the structured protein products will have average shear strength of at least 2500 grams. In a further embodiment, the structured protein products will have average shear strength of at least 2600 grams.

A means to quantify the size of the protein fibers formed in the structured protein products may be done by a shred characterization test. Shred characterization is a test that generally determines the percentage of large pieces formed in the structured protein product. In an indirect manner, percentage of shred characterization provides an additional means to quantify the degree of protein fiber alignment in a structured protein product. Generally speaking, as the percentage of large pieces increases, the degree of protein fibers that are aligned within a structured protein product also typically increases. Conversely, as the percentage of large pieces decreases, the degree of protein fibers that are aligned within a structured protein product also typically decreases. A method for determining shred characterization is detailed in Example 7. The structured protein products of the invention typically have an average shred characterization of at least 10% by weight of large pieces. In a further embodiment, the structured protein products have an average shred characterization of from about 10% to about 15% by weight of large pieces. In another embodiment, the structured protein products have an average shred characterization of from about 15% to about 20% by weight of large pieces. In yet another embodiment, the structured protein products have an average shred characterization of from about 20% to about 25% by weight of large pieces. In another embodiment, the average shred characterization is at least 20% by weight, at least 21% by weight, at least 22% by weight, at least 23% by weight, at least 24% by weight, at least 25% by weight, or at least 26% by weight large pieces.

Suitable structured protein products of the invention generally have protein fibers that are substantially aligned, have average shear strength of at least 1400 grams, and have an average shred characterization of at least 10% by weight large pieces. More typically, the structured protein products will have protein fibers that are at least 55% aligned, have average shear strength of at least 1800 grams, and have an average shred characterization of at least 15% by weight large pieces. In an exemplary embodiment, the structured protein products will have protein fibers that are at least 55% aligned, have average shear strength of at least 2000 grams, and have an average shred characterization of at least 17% by weight large pieces. In another exemplary embodiment, the structured protein products will have protein fibers that are at least 55% aligned, have average shear strength of at least 2200 grams, and have an average shred characterization of at least 20% by weight large pieces. In a further embodiment, the structured protein products will have protein fibers that are at least 55% aligned, have average shear strength of at least 2400 grams, and have an average shred characterization of at least 20% by weight large pieces.

### (II) Ground Meat and Meat Analog Compositions

The structured protein products are utilized in the invention as a component in ground meat and meat analog compositions. A ground meat composition may comprise a mixture of animal meat and structured plant protein product, or it may comprise no animal meat and primarily structured plant protein product. The process for producing the ground meat compositions generally comprises optionally mixing it with animal meat, coloring and hydrating the structured protein product, reducing its particle size, and further processing the composition into a food product comprising ground meat.

(a) Optionally Blend with Animal Meat

The structured protein product may be blended with animal meat to produce animal meat compositions either before or after contacting the structured protein product with the coloring composition detailed below. In general, the structured protein product will be blended with animal meat that has a similar particle size.

(i) Animal Meat

The animal meat compositions, in addition to structured plant protein product, also comprise animal meat. By way of example, meat and meat ingredients defined specifically for the various structured vegetable protein patents include intact or ground beef, pork, lamb, mutton, horsemeat, goat meat, meat, fat and skin of poultry (domestic fowl such as chicken, duck, goose or turkey) and more specifically flesh tissues from any fowl (any bird species), fish flesh derived from both fresh and salt water fish such as catfish, tuna, sturgeon, salmon, bass, muskie, pike, bowfin, gar, paddlefish, bream, carp, trout, walleye, snakehead and crappie, animal flesh of shellfish and crustacean origin, animal flesh trim and animal tissues derived from processing such as frozen residue from sawing frozen fish, chicken, beef, pork etc., chicken skin, pork skin, fish skin, animal fats such as beef fat, pork fat, lamb fat, chicken fat, turkey fat, rendered animal fat such as lard and tallow, flavor enhanced animal fats, fractionated or further processed animal fat tissue, finely textured beef, finely textured pork, finely textured lamb, finely textured chicken, low temperature rendered animal tissues such as low temperature rendered beef and low temperature rendered pork, mechanically separated meat or mechanically deboned meat (MDM) (meat flesh removed from bone by various mechanical means)such as mechanically separated beef, mechanically pork, mechanically separated fish including surimi, mechanically separated chicken, mechanically separated turkey, any cooked animal flesh and organ meats derived from any animal species. Meat flesh should be extended to include muscle protein fractions derived from salt fractionation of the animal tissues, protein ingredients derived from isoelectric fractionation and precipitation of animal muscle or meat and hot boned meat as well as mechanically prepared collagen tissues and gelatin. Additionally, meat, fat, connective tissue and organ meats of game animals such as buffalo, deer, elk, moose, reindeer, caribou, antelope, rabbit, bear, squirrel, beaver, muskrat, opossum, raccoon, armadillo and porcupine as well as well as reptilian creatures such as snakes, turtles and lizards should be considered meat.

It is also envisioned that a variety of meat qualities may be utilized in the invention depending upon the product's intended use. For example, intact muscle or whole muscle meat that are either ground or in chunk or steak form may be utilized. In an additional embodiment, mechanically deboned meat (MDM) may be utilized. In the context of the present invention, “MDM” is a meat paste that is recovered from a variety of animal bones, such as, beef, pork and chicken bones, using commercially available equipment. MDM is generally a comminuted product that is devoid of the natural fibrous texture found in intact muscles. In other embodiments, a combination of MDM and whole meat muscle may be utilized.

Typically, the amount of structured plant protein product in relation to the amount of animal meat in the animal meat compositions can and will vary depending upon the composition's intended use. By way of example, when a predominantly structured vegetable or plant protein composition that has a relatively small degree of animal flavor is desired, the concentration of animal meat in the ground meat composition may be about 45%, 40%, 35%, 30%, 25%, 20%, 15%, 10%, 5%, 2%, or 0% by weight. Alternatively, when an animal meat composition having a relatively high degree of animal meat flavor is desired, the concentration of animal meat in the animal meat composition may be about 50%, 55%, 60%, 65%, 70%, 75%, 80%, 85%, 90% or 95% by weight. Consequently, the concentration of structured plant protein product in the ground meat composition may be about 5%, 10%. 15%, 20%, 25%, 30%, 35%, 40%, 45%, 50%, 55%, 60%, 65%, 70%, 75%, 80%, 85%, 90%, 95%, or 99% by weight. In an exemplary embodiment, the ground meat composition will generally have from about 40% to about 60% by weight of the structured protein product and from about 40% to about 60% by weight of animal meat.

Depending upon the food product, the animal meat is typically pre-cooked to partially dehydrate the flesh and prevent the release of those fluids during further processing applications (e.g., such as retort cooking), to remove natural liquids or oils that may have strong flavors, to coagulate the animal protein and loosen the meat from the skeleton, or to develop desirable and textural flavor properties. The pre-cooking process may be carried out in steam, water, oil, hot air, smoke, or a combination thereof. The animal meat is generally heated until the internal temperature is between 60° C. and 85° C. In one embodiment, the animal meat composition is mixed with the hydrated structured plant protein at an elevated temperature corresponding to the temperature of the meat product.

### (III) Process for Producing Food Products Comprising Animal Meat and Simulated Meat Compositions

Another aspect of the invention provides a process for producing food products comprising animal meat compositions. An animal meat composition may comprise a mixture of animal meat and structured plant protein product, or it may comprise structured plant protein product. The process generally comprises hydrating the structured plant protein product, reducing its particle size if necessary, optionally flavoring and coloring the structured plant protein product, optionally mixing it with animal meat, and further processing the composition into a food product.

### (b) Hydrating and Coloring the Structured Protein Product

The structured plant protein product may be mixed with water to rehydrate it. The amount of water added to the structured plant protein product can and will vary. The ratio of water to structured plant protein product may range from about 1.5:1 to about 4:1. In a preferred embodiment, the ration of water to structured plant protein product may be about 2.5:1.

The structured protein product is generally colored with a coloring composition so as to resemble raw ground meat and/or cooked ground meat. The coloring compositions of the invention may comprise a thermally unstable pigment, a thermally stable pigment, and/or a browning agent. The choice of the type of pigments and the amount present in the coloring composition can and will vary depending upon the desired color of the ground meat composition. When the ground meat composition simulates a “pre-cooked product,” the structured plant product is typically contacted with a browning agent and/or a thermally stable pigment. Alternatively, when the ground meat composition simulates raw meat, the structured protein product is generally contacted with a thermally unstable red pigment and also with a browning agent and/or a thermally stable pigment, such that when the ground meat composition is cooked its appearance changes from a raw meat color to fully cooked color. Suitable thermally unstable red pigments, thermally stable pigments, and browning agents are described below.

A thermally unstable pigment may be used in the coloring composition to provide the red color of raw uncooked ground meat. The thermally unstable pigment is typically a food coloring dye or powder having a red color that resembles the red coloration of browning meat in its uncooked state (i.e., raw meat). Generally speaking, the thermally unstable pigment is a food coloring dye or powder having a structure that is degraded upon exposure to temperatures effective to cook a structured protein product. In this manner, the pigment is degraded thermally and as such, is ineffective to provide substantial coloration to the structured protein product when it is cooked. The thermally unstable pigment is typically degraded at temperatures of about 100° C. or greater, more preferably at temperatures of about 75° C. or greater, and most typically at temperatures of about 50° C. or greater. In one embodiment, the thermally unstable pigment is betanin, a red food coloring dye or powder having poor thermal stability. Betanin is derived from red beets and is typically prepared from red beet juice or beet powder. The thermally unstable pigment may be present in the coloring composition from about 0.005% to about 30% by dry weight of the coloring composition. When the thermally unstable pigment is betanin, the betanin preferably forms from about 0.005% to about 0.5% of the coloring composition by dry weight, and more preferably forms from about 0.01% to about 0.05% of the coloring composition by dry weight. Alternatively, a beet powder or beet extract preparation containing betanin may be present in the coloring composition from about 5% to about 30% of the composition by dry weight, and more preferably from about 10% to about 20% of the coloring composition.

A thermally stable pigment comprised of one or more thermally stable food coloring dyes may be used in the coloring composition. Suitable thermally stable pigments include those that are effective to provide a structured protein product with coloration resembling browned meat in both an uncooked state and a cooked state. Suitable thermally stable pigments include caramel food coloring material, and yellow or orange food-coloring agents. A variety of caramel food coloring agents are useful in the present invention and are commercially available in a powdered form or in a liquid form, including Caramel Color No. 602 (available from the D. D. Williamson Company, Louisville, Ky.), and 5438 Caramel Powder D.S. (available from Sensient Colors, St. Louis, Mo.).

Several types of commercially available yellow/orange food colorings may be used in the thermally stable pigment. Suitable yellow/orange food colors include annatto, turmeric, and artificial yellow dyes such as FD&C Yellow #5, cumin, saffron, yellow #6, and carotene. The amount of thermally stable pigment present in the coloring composition is from about 0% to about 7% by dry weight of the coloring composition, and more preferably from about 0.1% to about 3% by dry weight of the coloring composition. The yellow/orange food coloring material, preferably annatto, may constitute from about 0% to about 2% of the coloring composition by dry weight, and preferably is present in about 0.01% to about 1%, by dry weight of the coloring composition. The caramel food coloring material typically constitutes from about 0% to about 5% by dry weight, and preferably from about 1% to about 3%, by dry weight of the coloring composition.

The coloring composition may include a browning agent. As detailed in I(b), the browning agent generally causes a protein containing material in which the coloring composition is mixed to brown similarly to cook browning meat when the protein material is cooked. An exemplary browning agent is a reducing sugar. Suitable reducing sugars are typically capable of undergoing a Maillard browning reaction in the presence of compounds containing amine groups to provide the desired browning when a protein containing material is cooked. Representative examples of suitable reducing sugars include xylose, arabinose, galactose, mannose, dextrose, lactose and maltose. In an exemplary embodiment, the reducing sugar is dextrose. The reducing sugar may be present in the coloring composition from about 25% to about 95% by dry weight of the coloring composition, and preferably from about 35% to about 45% by dry weight of the coloring composition.

In an alternative embodiment, the browning agent of the coloring composition may also include an amine source. Suitable amine sources include a polypeptide material, a hydrolyzed protein material, or an amino acid material. The polypeptide material, hydrolyzed protein, and/or amino acid material are preferably included as an amine source in the browning agent to enhance the desired browning of the meat composition. In an exemplary embodiment, a hydrolyzed soy protein is the amino source in the browning agent. When included in the coloring composition, the amine source is generally present in the coloring composition from about 0.001% to about 55% of the coloring composition by dry weight.

In an exemplary embodiment, the coloring composition comprises beet pigment, annatto, caramel coloring, a reducing sugar, and an amino acid source. In one alternative of this embodiment, the reducing sugar is dextrose, and the amino acid source comprises peptides comprised of amino acids and secondary amino acids. In another alternative embodiment, the amino acid source is isolated soy protein.

The coloring composition may further comprise an acidity regulator to maintain the pH in the optimal range for the colorant. The acidity regulator may be an acidulent. Examples of acidulents that may be added to food include citric acid, acetic acid (vinegar), tartaric acid, malic acid, fumaric acid, lactic acid, phosphoric acid, sorbic acid, and benzoic acid. The final concentration of the acidulent in a coloring composition may range from about 0.001% to about 5% by weight of the coloring composition. The acidity regulator may also be a pH-raising agent, as known in the industry, such as disodium biphosphate, sodium tripolyphosphate, and/or sodium hydroxide.

The coloring composition of the present invention may be prepared by combining the components using processes and procedures known to those of ordinary skill in the art. The components are typically available in either a liquid form or a powder form, and often in both forms. The components can be mixed directly to form the coloring composition, but preferably the ingredients of the coloring composition are combined in an aqueous solution at a total concentration of about 1% to about 25% by weight, where the aqueous coloring solution can be conveniently added to a quantity of water for mixing with and coloring a structured protein product.

(c) Optional Blend with Animal Meat

The structured protein product may be blended with animal meat as described in II above, to produce animal meat compositions either before or after contacting the structured protein product with the coloring composition detailed below. In general, the structured protein product will be blended with animal meat that has a similar particle size.

### (d) Reducing Particle Size

Because the meat compositions are used in ground meat applications, the particle size of the structured plant protein product and animal meat, if present, is typically reduced to a relatively small particle size by passing the composition through though a meat grinder. The particle size can and will vary. In one embodiment, the particle size may be from about 1/16 of an inch to about 5/32 of an inch. In an exemplary embodiment, the particle size is from about ⅛ of an inch to about ¼ of an inch.

### (e) Addition of Optional Ingredients

The ground meat compositions including simulated meat compositions or the compositions blended with animal meat, may optionally include a variety of flavorings, spices, antioxidants, or other ingredients to impart a desired flavor or texture or to nutritionally enhance the final food product. As will be appreciated by a skilled artisan, the selection of ingredients added to the ground meat composition can and will depend upon the food product to be manufactured.

The ground meat composition may comprise from about 1% to about 30% by weight of a fat source to impart flavor. Typically, the fat source is an animal fat. Suitable animal fats include beef fat, pork fat, poultry fat and lamb fat. In an exemplary embodiment, the ground meat composition will comprise from about 10% to about 20% by weight of a fat source.

The ground meat composition may also comprise an isolated soy protein. Typically, the isolated soy protein is added in an amount that is sufficient to impart improved texture to the ground meat composition. Methods for determining “texture improvement” are detailed in the Examples.

The ground meat compositions may further comprise an antioxidant. The antioxidant may prevent the oxidation of the polyunsaturated fatty acids (e.g., omega-3 fatty acids) in the animal meat, and the antioxidant may also prevent oxidative color changes in the ground meat composition. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, m-aminobenzoic acid, o-aminobenzoic acid, p-aminobenzoic acid (PABA), butylated hydroxyanisole (BHA), butylated hydroxytoluene (BHT), caffeic acid, canthaxantin, alpha-carotene, beta-carotene, beta-caraotene, beta-apo-carotenoic acid, carnosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, rice bran extract, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. The concentration of an antioxidant in the ground meat composition may range from about 0.0001% to about 20% by weight. In another embodiment, the concentration of an antioxidant in the ground meat composition may range from about 0.001% to about 5% by weight. In yet another embodiment, the concentration of an antioxidant in the ground meat composition may range from about 0.01% to about 1% by weight.

In an additional embodiment, the ground meat compositions may further comprise at least one flavoring agent. The flavoring agent may be natural, or the flavoring agent may be artificial. The flavoring agent may mimic or replace constituents found in lean meat or fat tissues, such as, serum proteins, muscle proteins, hydrolyzed animal proteins, tallow, fatty acids, etc. The flavoring agent may provide an animal meat flavor, a grilled meat flavor, a rare beef flavor, etc. The flavoring agent may be an animal meat oil, spice extracts, spice oils, natural smoke solutions, or natural smoke extracts. Additional flavoring agents may include onion flavor, garlic flavor, or herb flavors. The ground meat composition may further comprise a flavor enhancer. Examples of flavor enhancers that may be used include salt (sodium chloride), glutamic acid salts (e.g., monosodium glutamate), glycine salts, guanylic acid salts, inosinic acid salts, 5′-ribonucleotide salts, hydrolyzed animal proteins, yeast extracts, Shiitake extracts, and hydrolyzed vegetable proteins. Examples of exemplary flavoring agents are described in the Examples.

In a further embodiment, the ground meat composition may be flavored through the addition of a flavored emulsion base, vegetable gum, and gelatin (flavored). Any known method may be used to produce the flavored emulsion base, for example U.S. Pat. No. 7,070,827 and U.S. published patent application 2006/0204644, hereby fully incorporated by reference, discloses a method for creating and including a flavor emulsion base.

In an additional embodiment, the ground meat compositions may further comprise a thickening or a gelling agent, such as alginic acid and its salts, agar, carrageenan and its salts, processed Eucheuma seaweed, gums (carob bean, guar, tragacanth, and xanthan), pectins, sodium carboxymethylcellulose, and modified starches.

In a further embodiment, the ground meat compositions may further comprise a nutrient such as a vitamin, a mineral, an antioxidant, an omega-3 fatty acid, an autolysed yeast flavoring, or an herb. Suitable vitamins include Vitamins A, C, and E, which are also antioxidants, and Vitamins B and D. Examples of minerals that may be added include the salts of aluminum, ammonium, calcium, magnesium, and potassium. Suitable omega-3 fatty acids include docosahexaenoic acid (DHA) and eicosapentanoic acid (EPA). Herbs that may be added include basil, celery leaves, chervil, chives, cilantro, parsley, oregano, tarragon, and thyme.

The ground meat compositions can be fortified with nutrients, such as vitamins, minerals, antioxidants, omega-3 fatty acids, or other nutrients typically found in animal meat products, to produce a food product with the desired nutrient value. The nutrients added to the ground meat and simulated meat are provided to create a product with a nutrient composition comparable to animal meat products. In an additional embodiment, the ground meat and simulated ground meat produced can be a nutraceutical. If a nutraceutical product is desired the type and amount of nutrients added will be such that the food product produced has a higher nutrient value than typical animal meat products. The types and amounts of nutrients added will depend on the desired end food product.

### (IV) Food Products

The ground meat compositions may be processed into a variety of food products having a variety of shapes. For example, the ground meat composition may be formed into a link, a patty, or into bulk packaging (i.e., chub and tube). In one exemplary embodiment, the ground meat composition is formed into a patty utilizing technology generally known in the art, such as a Formax F-6 fitted with a “Tenderform” forming plate. The patties may be pre-cooked fresh patties, pre-cooked frozen patties, raw frozen patties, and raw fresh patties. The patties may simulate the flavor and taste of a wide variety of all meat ground animal patties. Suitable patties may include beef patties (e.g., hamburger-like products), pork patties (i.e., sausage), lamb patties, and turkey patties.

In an exemplary embodiment, the ground meat composition will simulate ground beef. In one alternative of this embodiment, the ground beef product will comprise beef meat, structured plant protein product, water, isolated soy protein, antioxidant, spices and flavoring. In another alternative of this embodiment, the ground beef product will comprise beef meat, structured plant protein product, water, antioxidant, spices and flavoring. In yet another alternative of this embodiment, the ground beef product will comprise beef meat, structured plant protein product, water, caramel coloring, antioxidant, spices and flavoring. In a further alternative of this embodiment, the ground beef product will comprise beef meat, structured plant protein product, water, isolated soy protein, antioxidant, spices, flavoring and a coloring composition comprising beet powder, annatto, caramel coloring reducing sugar, and an amino acid source. In still another alternative of this embodiment, the ground beef product will comprise beef meat, structured plant protein product, beef broth, isolated soy protein, antioxidant, spices, and flavoring. In an additional alternative of this embodiment, the ground beef product will comprise beef meat, structured plant protein product, beef broth, water, isolated soy protein, antioxidant, spices, and flavoring. In each of the foregoing embodiments, the beef composition comprises from about 40% to about 60% by weight beef, from about 40% to about 60% by weight hydrated structured plant protein product, and from about 1% to about 20% beef fat.

The invention also encompasses a variety of food products comprising the ground meat compositions. For example, the ground meat compositions may be utilized in meatloaf, meatballs, batter-breaded products, and restructured products. The invention also encompasses ground meat analog compositions comprising primarily structured protein product, flavorings, and colorings such that the composition will simulate ground meat.

### DEFINITIONS

The term “extrudate” as used herein refers to the product of extrusion. In this context, the plant protein products comprising protein fibers that are substantially aligned may be extrudates in some embodiments.

The term “fiber” as used herein refers to a plant protein product having a size of approximately 4 centimeters in length and 0.2 centimeters in width after the shred characterization test detailed in Example 7 is performed. In this context, the term “fiber” does not include the nutrient class of fibers, such as soybean cotyledon fibers, and also does not refer to the structural formation of substantially aligned protein fibers comprising the plant protein products.

The term “animal meat” as used herein refers to the flesh, whole meat muscle, or parts thereof derived from an animal including beef, pork, poultry, wild game, fish and combinations thereof.

The term “gluten” as used herein refers to a protein fraction in cereal grain flour, such as wheat, that possesses a high content of protein as well as unique structural and adhesive properties.

The term “gluten free starch” as used herein refers to various starch products such as modified tapioca starch. Gluten free or substantially gluten free starches are made from wheat, corn, and tapioca based starches. They are gluten free because they do not contain the gluten from wheat, oats, rye, barley, corn gluten, or distillers grain products.

The term “large piece” as used herein is the manner in which a colored or uncolored structured plant protein product's shred percentage is characterized. The determination of shred characterization is detailed in Example 7.

The term “protein fiber” as used herein refers the individual continuous filaments or discrete elongated pieces of varying lengths that together define the structure of the plant protein products of the invention. Additionally, because both the colored and uncolored structured plant protein products of the invention have protein fibers that are substantially aligned, the arrangement of the protein fibers impart the texture of whole meat muscle to the colored and uncolored structured plant protein products.

The term “simulated” as used herein refers to an animal meat composition that contains no animal meat.

The term “soy cotyledon fiber” as used herein refers to the polysaccharide portion of soy cotyledons containing at least about 70% dietary fiber. Soy cotyledon fiber typically contains some minor amounts of soy protein, but may also be 100% fiber. Soy cotyledon fiber, as used herein, does not refer to, or include, soy hull fiber. Generally, soy cotyledon fiber is formed from soybeans by removing the hull and germ of the soybean, flaking or grinding the cotyledon and removing oil from the flaked or ground cotyledon, and separating the soy cotyledon fiber from the soy protein material and soluble carbohydrates of the cotyledon.

The term “soy protein concentrate” as used herein is a soy material having a protein content of from about 65% to less than about 90% soy protein on a moisture-free basis. Soy protein concentrate also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon, and separating the soy protein and soy cotyledon fiber from the soluble carbohydrates of the cotyledon.

The term “soy flour” as used herein, refers to a comminuted form of defatted soybean material, preferably containing less than about 1% oil, formed of particles having a size such that the particles can pass through a No. 100 mesh (U.S. Standard) screen. The soy cake, chips, flakes, meal, or mixture of the materials are comminuted into soy flour using conventional soy grinding processes. Soy flour has a soy protein content of about 49% to about 65% on a moisture free basis.

The term “soy protein isolate” as used herein is a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “strand” as used herein refers to a plant protein product having a size of approximately 2.5 to about 4 centimeters in length and greater than approximately 0.2 centimeter in width after the shred characterization test detailed in Example 7 is performed.

The term “starch” as used herein refers to starches derived from any native source. Typically sources for starch are cereals, tubers, roots, legumes, and fruits.

The term “wheat flour” as used herein refers to flour obtained from the milling of wheat. Generally speaking, the particle size of wheat flour is from about 14 to about 120 μm.

The following examples are included to demonstrate preferred embodiments of the invention. It should be appreciated by those skilled in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the accompanying drawings is to be interpreted as illustrative and not in a limiting sense

### EXAMPLES

Examples 1-8 illustrate various embodiments of the invention.

### Example 1

### Healthier Beef Patties comprising 40% Meat Replacement and Flavoring Agents

One goal of this research was to develop a healthier beef patty in which part of the beef was replaced with hydrated structured vegetable protein (SVP) ingredient, such that a patty containing as little as 10% fat would be considered to taste like an all beef patty with a much higher fat content. Flavor development objectives included: (1) develop and optimize flavoring systems that mask the slight cereal and soy flavors inherent to the SVP and possibly isolated soy protein (ISP) ingredients, (2) enhance meat flavors of the meat remaining in the formulation; and (3) add meat flavors to replace flavor components lost through meat replacement.

Healthier beef patties were prepared in which 40% of the beef was replaced with hydrated SVP and ISP ingredients, such that the patties were 90% lean. Table 1 present the nutritional profile of beef/SVP patties and traditional beef patties. The beef/SVP patties had 30% less calories, 50% less fat, and 40% less cholesterol than 80% lean beef patties.

Two different types of beef/SVP patties were prepared, each having a different combination of flavoring agents provided by International Flavor & Fragrances, Inc. (IFF) that impart various aspects of beef flavor. Flavoring agents IFF #711300 and 711303 were added to one (T5), and flavoring agents IFF #711300, 711302, 711303, and 711304 were added to the other (T6). The sensory profiles of T5, T6, and 80% lean all beef patties were compared using several different sensory evaluations as described in Examples 2 and 3.

TABLE 1
Nutrition Facts

| | |
|---|---|
| | Raw Beef/SVP |
| Raw Beef Patty | Patty |

| | | | | |
|---|---|---|---|---|
| Serving Size | 114 | g | 114 | g |
| Calories | 90 | | 210 | |
| Protein | 19 | g | 21 | g |
| Total Fat | 23 | g | 12 | g |
| Cholesterol | 80 | mg | 45 | mg |
| Total Carbohydrate | 0 | g | 3 | g |
| Sodium | 250 | mg | 400 | mg |

### Example 2

### Sensory Analysis of Precooked Patties Using a Hedonic Acceptance Scale

The three types of patties prepared in Example 1 were evaluated by 69 sensory panelists who regularly consumed beef patties. The three types of raw patties were precooked to an internal temperature of 160° F. and frozen. Tempered patties were reheated to an internal temperature of 150° F. in a 350° F. convection oven. Each panelist received a whole beef/SVP or all beef patty on a 6″ white styrofoam disposable plate with a unique 3-digit code for identification purposes. The patties were presented sequential monadically (one at a time), and the serving order was rotated so the each that each type of patty was seen first an equal number of times.

The sensory characteristics of each patty were evaluated using 9-point hedonic acceptance scale, where 1=extremely dislike, 5=neither like nor dislike, and 9=extremely like. The following sensory attributes were rated:
Liking of Overall Product
Liking of Flavor
Liking of Texture
Liking of Juiciness
   The scores were tabulated; the mean, median, and standard deviation were calculated. The data were further analyzed using an analysis of variance, accounting for panelist and sample effects, with means separations using Tukey's significant difference (HSD) test.

FIG. 3 presents the mean liking scores for each sensory characteristic, and the data are summarized in Tables 2-5. The T5 patty had the highest mean score for each attribute evaluated. In terms of “overall liking,” T5 had a mean rating of 6.47, which was significantly different from both T6 (5.78) and all beef patties (5.49) (Table 2).

TABLE 2
Summary of Overall Liking Scores

| | | | | Standard |
|---|---|---|---|---|
| Sample | Count | Median | Mean¹ | Deviation |
| All Beef | 68 | 6.00 | 5.49 b | 2.189 |
| T5 | 68 | 7.00 | 6.47 a | 1.569 |
| T6 | 68 | 6.00 | 5.78 b | 1.674 |

¹Means sharing a common letter were not different (P > 0.05).

In terms “liking of flavor,” T5 had the highest mean liking score (6.47), which was significantly different from T6 (5.79). The mean score for the all beef control (6.04) fell between the two test samples (Table 3).

TABLE 3
Summary of Liking of Flavor Scores

| | | | | Standard |
|---|---|---|---|---|
| Sample | Count | Median | Mean¹ | Deviation |
| All Beef | 68 | 7.00 | 6.04 ab | 2.147 |
| T5 | 68 | 7.00 | 6.47 a | 1.643 |
| T6 | 68 | 6.00 | 5.79 b | 1.715 |

¹Means sharing a common letter were not different (P > 0.05).

With regard to “liking of texture,” again T5 had the highest mean liking score (6.44), which was significantly different from both T5 (5.94) and the all beef control (5.53) (Table 4).

TABLE 4
Summary of Liking of Texture Scores

| | | | | Standard |
|---|---|---|---|---|
| Sample | Count | Median | Mean¹ | Deviation |
| All Beef | 68 | 6.00 | 5.53 b | 2.216 |
| T5 | 68 | 7.00 | 6.44 a | 1.782 |
| T6 | 68 | 6.00 | 5.94 ab | 1.674 |

¹Means sharing a common letter were not different (P > 0.05).

Lastly, T5 had the highest average “liking of juiciness” score (6.44), with T6 (6.13) scoring nearly as high. Both of these were significantly different from the all beef control (4.88) (Table 5).

TABLE 5
Summary of Liking of Juiciness Scores

| | | | | Standard |
|---|---|---|---|---|
| Sample | Count | Median | Mean¹ | Deviation |
| All Beef | 68 | 5.00 | 4.88 b | 2.236 |
| T5 | 68 | 7.00 | 6.44 a | 1.633 |
| T6 | 68 | 6.00 | 6.13 a | 1.573 |

¹Means sharing a common letter were not different (P > 0.05).

The panelists also rated the patties according to their similarity to beef patties using a 5-point scale, where 1=not at all like beef patties and 5=exactly like beef patties. FIG. 4 presents the mean scores for the different patties, and Table 6 summarizes the data. T5 had the highest mean similarity score (3.51), which differed from T6 (3.06) (Table 6). The all beef control (3.31) fell between the two test samples.

TABLE 6
Summary of Similarity to Beef Patties Scores

| | | | | Standard |
|---|---|---|---|---|
| Sample | Count | Median | Mean¹ | Deviation |
| All Beef | 68 | 3.00 | 3.31 ab | 1.284 |
| T5 | 68 | 4.00 | 3.51 a | 1.000 |
| T6 | 68 | 3.00 | 3.06 b | 1.020 |

¹Means sharing a common letter were not different (P > 0.05).

### Example 3

### Sensory Analysis of Precooked Patties Using the Sensory Spectrum Descriptive Profiling Method

The three types of patties prepared in Example 1 were also rated by 11 panelists that were trained in the Sensory Spectrum Descriptive Profiling Method. Sixteen flavor or sensory attributes were evaluated on a 15-points scale, with 0=none/not applicable and 15=very strong/high in the sample. The attributes and their definitions are presented in Table 7. The intensity scores were based upon the following references for flavor attributes:
2.5 Baking soda note in a saltine cracker
5.0 Cooked apple note in Motts Applesauce
7.5 Cooked orange note in MinuteMaid Orange Juice
10.0 Cooked note in Welch's Concord Grape Juice
12.0 Cinnamon note in Big Red Gum

TABLE 7
Meat Patty Flavor Lexicon

| Attribute | Preparation | Reference | |
|---|---|---|---|
| AROMATICS | | | |
| Overall Flavor | The overall intensity of the product | | |
| Impact | aromas, an amalgamation of all | | |
| | perceived aromatics, basic tastes and | | |
| | chemical feeling factors. | | |
| Meat Complex | The general category used to describe | | |
| | the total meat flavor impact of the | | |
| | product | | |
| Beef | The aromatic associated with lean red | Cooked (boiled) lean | |
| | meat | ground beef | |
| Pork | Aromatic associated with cooked/cured | Ground pork, Pork | |
| | lean pork | trimmed of visible fat. | |
| Chicken | The aromatics associated with freshly | Ground Chicken, | |
| | cooked chicken. | Baked/broiled chicken | |
| | | breasts/thighs. | |
| Fat | Aromatic reminiscent of dairy lipid | Melted butter, Crisco, | |
| | products, melted vegetable shortening | boiled chicken skins, | |
| | cooked chicken skin, and beef tallow | beef tallow. | |
| Browned/ | The aromatic associated with the | Broiled meat, roasted | |
| Caramelized/ | outside of grilled or broiled meat. | chicken breast | |
| Roasted | | | |
| TVP/Vegetative | The aromatic associated with texturized | Hydrated TVP | |
| | vegetable protein (TVP) | | |
| Onion/Garlic | The aromatics associated with | Onion, garlic and celery | |
| | dehydrated onion and garlic powders | powder solutions. Garlic | |
| | | Oil Capsules | |
| White/Black | The aromatic associated with white and | White pepper and black | |
| Pepper | black pepper | pepper solutions | |
| BASIC | | | |
| TASTES | | | |
| Sweet | The taste on the tongue stimulated by | Sucrose solution: | |
| | sucrose and other sugars, such as | 2% | 2.0 |
| | fructose, glucose, etc., and by other | 5% | 5.0 |
| | sweet substances, such as Aspartame, | | |
| | and Acesulfame-K. | | |
| Sour | The taste on the tongue stimulated by | Citric acid solution: | |
| | acid, such as citric, malic, phosphoric, | 0.05% | 2.0 |
| | etc. | 0.08% | 5.0 |
| Salt | The taste on the tongue associated with | Sodium chloride solution: | |
| | sodium salts | | |
| | | 0.2% | 2.0 |
| | | 0.35% | 5.0 |
| Bitter | The taste on the tongue associated with | Caffeine solution: | |
| | caffeine and other bitter substances, | 0.05% | 2.0 |
| | such as quinine and hop bitters. | 0.08% | 5.0 |
| Umami | The taste on the tongue associated with | MSG solution: | |
| | monosodium glutamate. Savory. | 6% | 5.0 |
| CHEMICAL FEELING FACTOR | | | |
| Astringent | The shrinking or puckering of the tongue | Alum solution: | |
| | surface caused by substances such as | 0.005% | 3.0 |
| | tannins or alum. | 0.0066% | 5.0 |

Patties were heated in a standard oven maintained at 300° F. Foil was used to maintain moisture in the samples during reconstitution. The patties were brought to an internal temperature to 175° F. before serving. Panelists were given four quarters from different patties per evaluation. The samples were presented monadically in duplicate.

Table 8 presents the mean scores for flavor attributes for the three types of patties. Analysis of variance (ANOVA) was performed to test product and replication effects. When the ANOVA result was significant, multiple comparisons of means were performed using the Tukey's HSD t-test. All differences were significant at a 95% confidence level unless otherwise noted. For flavor attributes, mean values<1.0 indicate that not all panelists perceived the attribute in the sample. A value of 2.0 is threshold for all flavor attributes, which is the minimum level that the panelist can detect and still identify the attribute. The attributes at threshold or lower are in gray font, and attributes above thresholds are in black font in Table 8.

TABLE 8
Mean¹ Scores for Flavor Attributes.

| | | | | P |
|---|---|---|---|---|
| | All Meat | T5 | T6 | value |
| Aromatics | | | | |
| Overall Flavor | 6.4 a | 6.2 b | 6.4 a | ** |
| Impact | | | | |
| Meat Complex | 5.3 a | 3.0 b | 2.5 c | *** |
| Beef | 5.0 a | 2.9 b | 2.5 c | *** |
| Pork | 0.0 a | 0.0 a | 0.0 a | n/a |
| Chicken | 0.0 a | 0.0 a | 0.0 a | n/a |
| Fat | 2.3 a | 1.5 b | 1.6 b | *** |
| Browned/Roasted/ | 2.9 c | 3.7 a | 3.3 b | *** |
| Caramelized | | | | |
| TVP/Vegetative | 0.0 c | 3.1 b | 3.8 a | *** |
| Onion/Garlic | 2.4 a | 2.6 a | 2.6 a | * |
| White/Black Pepper | 2.2 a | 2.2 a | 2.2 a | NS |
| Basic Tastes and | | | | |
| Feeling Factors | | | | |
| Sweet | 0.2 b | 0.6 a | 0.6 a | ** |
| Sour | 2.1 b | 2.1 ab | 2.2 a | *** |
| Salt | 4.3 a | 4.4 a | 4.4 a | NS |
| Bitter | 2.1 b | 2.4 a | 2.5 a | *** |
| Umami | 2.7 b | 3.2 a | 3.1 a | *** |
| Astringent | 2.1 b | 2.2 [symbol] | 2.3 a | *** |
| Other: Metallic | 2.0 (9%) | 0.0 | 0.0 | |

¹Means in the same row sharing a common letter were not different (P > 0.05).
*** 95% Confidence,
** 90% Confidence,
* 80% Confidence,
NS—Not Significant
The attributes at threshold or lower are gray. The attributes above threshold are black. For other attributes, % score is the percentage of times the attribute was perceived.

The major flavor differences between T5 and the all beef control were that T5 scored slightly lower in “overall flavor impact” and significantly lower in “meat complex,” “beef,” and “meat fat” aromatics. T5 scored significantly higher in “TVP/vegetative” and “browned/roasted/caramelized” aromatics, and slightly higher in the “onion/garlic,” “bitter,” “umami,” and “astringent” attributes than the all beef control. T5 and the control were similar in the “black pepper” and “salty” attributes. A comparison of T6 and the all beef control revealed that T6 scored significantly lower in “meat complex,” “beef,” and “meat fat” aromatics. Similar to T5, T6 also scored significantly higher in “TVP/vegetative” and “browned/roasted/caramelized” aromatics, and slightly higher in the “onion/garlic,” “bitter,” “umami,” and “astringent” attributes than the all beef control. T6 and the all beef control were similar in “overall flavor impact” and “black pepper” and “salty” attributes. In summary, this sensory analysis revealed that T5 scored very close to the all beef control patties in terms of “meaty” and “beefy’ aromatics.

### Example 4

### Sensory Analysis of Raw Prefrozen Patties Using the Hedonic Acceptance Scale

A series of beef/SVP and all beef patties that were frozen before cooking were also evaluated for several sensory characteristics. Healthier beef patties were prepared that included 40% SVP and 1% ISP, and the beef/SVP mixture was ground through ⅛^{th} inch or 3/16^{th} inch grinder plates. All beef patties that were 80% lean or 90% lean were ground through ⅛^{th} inch grinder plates.

The four different patties were evaluated by 60 sensory panelists who regularly consumed beef patties. Patties were grilled from a frozen state to an internal temperature of 161° F. and held warm in a food-service water bath unit to maintain temperature. Each panelist received half of a patty on 6″ white styrofoam disposable plate with a unique 3-digit code for identification purposes. The patties were presented sequential monadically (one at a time), and the serving order was rotated so the each that each type of patty was seen first an equal number of times.

The sensory characteristics of each patty were evaluated using the 9-point hedonic acceptance scale, where 1=extremely dislike, 5=neither like nor dislike, and 9=extremely like. The following sensory attributes were rated.
Liking of Overall Product
Liking of Flavor
Liking of Texture
Liking of Juiciness

The mean overall liking scores are presented in FIG. 5 and summarized in Tables 9-12. In general, the 80% lean beef patty scored highest in all attributes, with the ⅛^{th} inch grind beef/SVP patty scoring nearly as high.

TABLE 9
Summary of Liking of Overall Product Scores

| | | | | Standard |
|---|---|---|---|---|
| Sample | Count | Median | Mean¹ | Deviation |
| 80% Beef | 60 | 7.00 | 6.88 a | 1.678 |
| 90% Beef | 60 | 6.50 | 6.05 b | 1.978 |
| Beef/SVP ⅛″ | 60 | 6.00 | 5.83 b | 1.906 |
| Beef/SVP 3/16″ | 60 | 6.00 | 5.43 b | 1.899 |

¹Means sharing a common letter were not different (P > 0.05).

TABLE 10
Summary of Liking of Appearance Scores

| | | | | Standard |
|---|---|---|---|---|
| Sample | Count | Median | Mean¹ | Deviation |
| 80% Beef | 60 | 7.00 | 6.50 a | 1.546 |
| 90% Beef | 60 | 6.00 | 6.03 a | 2.025 |
| Beef/SVP ⅛″ | 60 | 7.00 | 6.37 a | 1.573 |
| Beef/SVP 3/16″ | 60 | 6.00 | 6.22 a | 1.738 |

¹Means sharing a common letter were not different (P > 0.05).

TABLE 11
Summary of Liking of Flavor Scores

| | | | | Standard |
|---|---|---|---|---|
| Sample | Count | Median | Mean¹ | Deviation |
| 80% Beef | 60 | 7.00 | 6.95 a | 1.641 |
| 90% Beef | 60 | 7.00 | 6.52 a | 1.970 |
| Beef/SVP ⅛″ | 60 | 6.00 | 5.50 b | 2.175 |
| Beef/SVP 3/16″ | 60 | 5.00 | 5.03 b | 2.170 |

¹Means sharing a common letter were not different (P > 0.05).

TABLE 12
Summary of Liking of Texture Scores

| | | | | Standard |
|---|---|---|---|---|
| Sample | Count | Median | Mean¹ | Deviation |
| 80% Beef | 60 | 7.00 | 6.72 a | 1.823 |
| 90% Beef | 60 | 6.00 | 5.85 b | 2.073 |
| Beef/SVP ⅛″ | 60 | 6.00 | 5.88 b | 1.833 |
| Beef/SVP 3/16″ | 60 | 5.00 | 5.37 b | 2.099 |

¹Means sharing a common letter were not different (P > 0.05).

### Example 5

### Color Analysis of Raw and Cooked Patties

Another goal was to develop a healthier beef patty comprising beef and structured vegetable protein (SVP) whose color resembled that of raw all-beef patties. Prior to cooking, the beef/SVP patty should resemble fresh red meat containing about 10-30% fat, and the red beef/SVP patty should turn brown during cooking. The coloring system (see Table 13) comprised unstable red pigment and other pigments, natural flavor enhancer (source of amino acids), and reducing sugar. With this system, when the product was subjected to heat, the unstable red color pigment faded while reducing sugars reacted with amino acids in the natural flavor enhancer to develop brown color. The SVP was hydrated in the colored hydration solution; the formulations of healthier beef patty and traditional beef patty are presented in Table 14.

TABLE 13
SVP Hydration and Coloring Formulation

| | Formulation |
|---|---|
| Ingredient | Content (%) |
| Annatto | 0.0020 |
| Beet Powder | 0.5500 |
| Dextrose | 1.3397 |
| Natural Flavor Enhancer | 0.6450 |
| (Kikkoman) (amino group) | |
| Water | 97.4633 |
| Total | 100.0000 |

TABLE 14
Patty Formulations

| | Beef/SVP | Beef Patty |
|---|---|---|
| Ingredient | (%) | (%) |
| Beef (lean) | 45.38 | 77.70 |
| Beef Fat | 10.02 | 21.50 |
| SVP (SUPROMAX 5050) | 10.00 | |
| Hydration and Coloring | 30.00 | |
| Solution (see Table 13) | | |
| ISP | 1.00 | |
| Water | 2.00 | |
| Flavors | 1.25 | |
| Salt | 0.15 | 0.60 |
| Herb/Spice | 0.20 | 0.20 |
| Total | 100.00 | 100.00 |

The raw beef/SVP patty was similar in color and appearance to an 80% lean all beef patty (FIG. 6A). All of the patties were cooked to an internal temperature of 165° F. Again the cooked beef/SVP patty was similar in color and appearance to the all beef patty (FIGS. 6B and C). The color of the different raw and cooked patties was analyzed using a numerical system. One system is Hunter Lab Color Scale that describes color three dimensionally for utilizing L-, a- and b-values. The L-Value describes brightness or darkness; with zero equivalent to black and 100 equivalent to white. The a- and b- axes have no specific numerical limits. On the a-axis, a positive value is red and negative value is green. Similarly on the b-axis, a positive value is yellow and a negative value is blue.

The surface color of each raw patty was analyzed, and the internal color of each cooked patty was analyzed. The L-, a-, and b- values are presented in Table 15. Similar to the visual images presented in FIG. 6, all of the color values were quite similar between the healthier beef/SVP patty and the corresponding the all beef patty.

TABLE 15
Color Values of Beef/SVP and All Beef Patties

| | L-value | a-value | b-value |
|---|---|---|---|
| All Beef - raw, surface color | 46.28 | 20.45 | 13.55 |
| Beef/SVP - raw, surface color | 51.17 | 20.15 | 15.24 |
| All Beef - cooked, internal color | 50.82 | 8.16 | 13.36 |
| Beef/SVP - cooked, internal color | 51.65 | 9.80 | 15.40 |

### Example 6

### Determination of Shear Strength

Shear strength of a sample is measured in grams and may be determined by the following procedure. Weigh a sample of the structured plant protein product and place it in a heat sealable pouch and hydrate the sample with approximately three times the sample weight of room temperature tap water. Evacuate the pouch to a pressure of about 0.01 bar and seal the pouch. Permit the sample to hydrate for about 12 to about 24 hours. Remove the hydrated sample and place it on the texture analyzer base plate oriented so that a knife from the texture analyzer will cut through the diameter of the sample. Further, the sample should be oriented under the texture analyzer knife such that the knife cuts perpendicular to the long axis of the textured piece. A suitable knife used to cut the extrudate is a model TA-45, incisor blade manufactured by Texture Technologies (USA). A suitable texture analyzer to perform this test is a model TA, TXT2 manufactured by Stable Micro Systems Ltd. (England) equipped with a 25, 50, or 100 kilogram load. Within the context of this test, shear strength is the maximum force in grams needed to shear through the sample.

### Example 7

### Determination of Shred Characterization

A procedure for determining shred characterization may be performed as follows. Weigh about 150 grams of a structured plant protein product using whole pieces only. Place the sample into a heat-sealable plastic bag and add about 450 grams of water at 25° C. Vacuum seal the bag at about 150 mm Hg and allow the contents to hydrate for about 60 minutes. Place the hydrated sample in the bowl of a Kitchen Aid mixer model KM14G0 equipped with a single blade paddle and mix the contents at 130 rpm for two minutes. Scrape the paddle and the sides of the bowl, returning the scrapings to the bottom of the bowl. Repeat the mixing and scraping two times. Remove ˜200 g of the mixture from the bowl. Separate the ˜200 g of mixture into one of two groups. Group 1 is the portion of the sample having fibers at least 4 centimeters in length and at least 0.2 centimeters wide. Group 2 is the portion of the sample having strands between 2.5 cm and 4.0 cm long, and which are ≧0.2 cm wide. Weigh each group, and record the weight. Add the weight of each group together, and divide by the starting weight (e.g. ˜200 g). This determines the percentage of large pieces in the sample. If the resulting value is below 15%, or above 20%, the test is complete. If the value is between 15% and 20%, then weigh out another ˜200 g from the bowl, separate the mixture into groups one and two, and perform the calculations again.

### Example 8

### Production of Structured Plant Protein Products

The following extrusion process may be used to prepare the structured plant protein products of the invention, such as the soy structured plant protein products utilized in Examples 6 and 7. Added to a dry blend mixing tank are the following: 1000 kilograms (kg) Supro® 620 (soy isolate), 440 kg wheat gluten, 171 kg wheat starch, 34 kg soy cotyledon fiber, 9 kg dicalcium phosphate, and 1 kg L-cysteine. The contents are mixed to form a dry blended soy protein mixture. The dry blend is then transferred to a hopper from which the dry blend is introduced into a preconditioner along with 480 kg of water to form a conditioned soy protein pre-mixture. The conditioned soy protein pre-mixture is then fed to a twin-screw extrusion apparatus (Wenger Model TX-168 extruder by Wenger Manufacturing, Inc. (Sabetha, Kans.))at a rate of not more than 25 kg/minute. The extrusion apparatus comprises five temperature control zones, with the protein mixture being controlled to a temperature of from about 25° C. in the first zone, about 50° C. in the second zone, about 95° C. in the third zone, about 130° C. in the fourth zone, and about 150° C. in the fifth zone. The extrusion mass is subjected to a pressure of at least about 400 psig in the first zone up to about 1500 psig in the fifth zone. Water, 60 kg per hour, is injected into the extruder barrel, via one or more injection jets in communication with a heating zone. The molten extruder mass exits the extruder barrel through a die assembly consisting of a die and a backplate. As the mass flows through the die assembly the protein fibers contained within are substantially aligned with one another forming a fibrous extrudate. As the fibrous extrudate exits the die assembly, it is cut with flexible knives and the cut mass is then dried to a moisture content of about 10% by weight.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the following claims.

What is claimed is:

1. A ground meat composition, the composition comprising:
a. structured plant protein product, the product having protein fibers that are substantially aligned;
b. animal meat; and
c. a color composition having coloring agents selected from the group consisting of a thermally unstable pigment, a thermally stable pigment, a reducing sugar, and combinations thereof.

2. The ground meat composition of claim 1, wherein the composition comprises from about 40% to about 60% by weight of the structured plant protein product, and from about 40% to about 60% by weight of animal meat.

3. The ground meat composition of claim 2, further comprising a fat source in an amount ranging from about 10% to about 20% by weight of the composition.

4. The ground meat composition of claim 1, wherein the structured plant protein product comprises protein fibers substantially aligned in the manner depicted in the micrographic image of FIG. 1.

5. The ground meat composition of claim 1, wherein the structured plant protein product has an average shear strength of at least 1400 grams and an average shred characterization of at least 10%

6. The ground meat composition of claim 3, wherein the structured plant protein product is selected form the group consisting of soy protein, starch, gluten, and fiber.

7. The ground meat composition of claim 3, wherein the structured plant protein product comprises:
a. from about 35% to about 65% soy protein on a dry matter basis;
b. from about 20% to about 30% wheat gluten on a dry matter basis;
c. from about 10% to about 15% wheat starch on a dry matter basis;
d. from about 1% to about 5% starch on a dry matter basis.

8. The ground meat composition of claim 5, wherein the animal meat is selected from beef, pork, lamb, poultry, wild game, fish, and mixtures thereof.

9. The ground meat composition of claim 7, wherein the coloring composition is selected from the group consisting of beet, annatto, carmel coloring, a reducing sugar, an amino acid source, and combinations thereof.

10. The ground meat composition of claim 8, further comprising isolated soy protein.

11. The ground meat composition of claim 9, further comprising an antioxidant water, spices and flavoring.

12. The ground meat composition of claim 10, wherein the animal meat is beef, and reducing sugar is dextrose, and the particle size of the composition is from about ⅛ of an inch to about ¼ of an inch.

13. A simulated ground meat composition, the simulated ground meat composition comprising:
(a) A structured plant protein product comprising protein fibers that are substantially aligned, the structured plant protein product comprising an extrudate of plant protein material; and,
(b) A color composition having coloring agents selected from the group consisting of a thermally unstable pigment, a thermally stable pigment, a reducing sugar, and combinations thereof

14. A process for coloring a ground meat composition, the process comprising contacting a mixture comprising structured plant protein product and animal meat with a coloring composition comprising beet, annatto, carmel coloring, dextrose, and an amino acid source.

15. The process of claim 14, wherein the structured plant protein product comprises:
a. from about 35% to about 65% soy protein on a dry matter basis;
b. from about 20% to about 30% wheat gluten on a dry matter basis;
c. from about 10% to about 15% wheat starch on a dry matter basis;
d. from about 1% to about 5% starch on a dry matter basis.

16. The process of claim 15, wherein the mixture comprises from about 5% to about 95% by weight of the structured plant protein product, and from about 5% to about 95% by weight of animal meat.

17. A food product comprising the ground meat composition of claim 1.

18. The food product of claim 17, wherein the food product is formed into a patty or link.

19. The food product of claim 18, wherein the patty is a beef patty or a sausage patty.

20. The food product of claim 17, comprising a product selected from the group consisting of meatballs, meat loaf, batter-breaded products, and restructured meat products.

21. A beef patty comprising the ground meat composition of claim 12.
